(19) United States
(12) Patent Application Publication
(10) Pub. No.: US 2022/0100457 A1
(43) Pub. Date: Mar. 31, 2022

(54) INFORMATION PROCESSING APPARATUS, INFORMATION PROCESSING SYSTEM, AND NON-TRANSITORY COMPUTER-EXECUTABLE MEDIUM

(71) Applicants: Mitsuki Yamasako, Kanagawa (JP); Masaki Arai, Tokyo (JP)

(72) Inventors: Mitsuki Yamasako, Kanagawa (JP); Masaki Arai, Tokyo (JP)

(73) Assignee: Ricoh Company, Ltd., Tokyo (JP)

(21) Appl. No.: 17/447,602

(22) Filed: Sep. 14, 2021

(30) Foreign Application Priority Data
Sep. 29, 2020 (JP) 2020-164182

(51) Int. Cl. G06F 3/14; H04L 29/06; G06F 3/0482; G06T 11/00; G06F 3/01

(52) U.S. Cl. CPC G06F 3/1454; H04L 65/403; G06F 3/013; G06T 11/001; G06F 3/0482

(57) ABSTRACT

An information processing apparatus is connected to a first communication terminal and a second communication terminal through a network. The information processing apparatus includes circuitry. The circuitry receives operation information indicating an operation performed on a capture image at the second communication terminal, the capture image being an image captured by the second communication terminal from a shared screen shared by the first communication terminal, the second communication terminal, and another communication terminal. The circuitry identifies a part where the operation is performed on the capture image, based on the received operation information. The circuitry transmits information on the part where the operation is performed to the first communication terminal.

### CROSS-REFERENCE TO RELATED APPLICATIONS

This patent application is based on and claims priority pursuant to 35 U.S.C. § 119(a) to Japanese Patent Application No. 2020-164182, filed on Sep. 29, 2020, in the Japan Patent Office, the entire disclosure of which is hereby incorporated by reference herein.

### BACKGROUND

### Technical Field

Embodiments of the present disclosure relate to an information processing apparatus, an information processing system, and a non-transitory computer-executable medium.

### Related Art

Recently, in events such as conferences, seminars, or presentation, documents provided by an organizer of such an event can be shared with a plurality of participants of the event through a communication network.

In such events, the organizer collects information in which the participant expressed interest in the documents shared in the event, and uses the collected information as reference information to be reflected in future events, etc.

For example, a conference support system is known in which an electronic conference apparatus acquires history information of operations performed on a conference document by a user of the electronic conference apparatus, calculates importance of the conference document based on the acquired history information, and a list of conference documents is presented to the user based on the calculated importance.

### SUMMARY

An embodiment of the present disclosure includes information processing apparatus connected to a first communication terminal and a second communication terminal through a network. The information processing apparatus includes circuitry. The circuitry receives operation information indicating an operation performed on a capture image at the second communication terminal, the capture image being an image captured by the second communication terminal from a shared screen shared by the first communication terminal, the second communication terminal, and another communication terminal. The circuitry identifies a part where the operation is performed on the capture image, based on the received operation information. The circuitry transmits information on the part where the operation is performed to the first communication terminal.

Another embodiment of the present disclosure includes a non-transitory computer-executable medium storing a program to cause an information processing apparatus connected to a first communication terminal and a second communication terminal through a network to perform a method. The method includes receiving operation information indicating an operation performed on a capture image at the second communication terminal, the capture image being an image captured by the second communication terminal from a shared screen shared by the first communication terminal, the second communication terminal, and another communication terminal. The method includes identifying a part where the operation is performed on the capture image, based on the received operation information. The method includes transmitting information on the part where the operation is performed to the first communication terminal.

Another embodiment of the present disclosure includes an information processing system connected to a first communication terminal and a second communication terminal through a network. The information processing system includes circuitry. The circuitry receives operation performed on a capture image displayed on the second communication terminal, the capture image being an image captured by the second communication terminal from a shared screen shared by the first communication terminal, the second communication terminal, and another communication terminal. The circuitry identifies a part where the operation is performed on the capture image, based on operation information indicating the received operation. The circuitry causes the first communication terminal to display information on the part where the operation is performed.

Another embodiment of the present disclosure includes an information processing system including the information processing apparatus, and the first communication terminal. The first communication terminal includes circuitry to display a screen based on the information on the part where the operation is performed, the information being received from the information processing apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an overview of an information sharing system, according to an embodiment of the present disclosure;

FIG. 2 is a schematic diagram illustrating an overview of a personal portal of the information sharing system, according to an embodiment of the present disclosure;

FIG. 3 is a block diagram illustrating an example of a hardware configuration, according to an embodiment of the present disclosure;

FIG. 4 is a block diagram illustrating an example of a functional configuration of the information sharing system, according to an embodiment of the present disclosure;

FIG. 5 is an illustration of an example of a screen layout of a personal board, according to an embodiment of the present disclosure;

FIG. 6 is an illustration of an example of a screen on which a shared screen is displayed in a shared screen display area, according to an embodiment of the present disclosure;

FIG. 7 is an illustration of an example of a screen on which a capture image is displayed in a capture image display area, according to an embodiment of the present disclosure;

FIG. 8 is diagram for describing an example of a personal memo management information table in a personal memo management database (DB), according to an embodiment of the present disclosure;

FIG. 9 is diagram for describing an example of a personal memo information table in a personal memo DB, according to an embodiment of the present disclosure;

FIG. 10 is a sequence diagram illustrating an example of operation of displaying the shared screen on the personal board, according to an embodiment of the present disclosure;

FIG. 11 is a sequence diagram illustrating an example of operation of displaying a capture image on the personal board dc, according to an embodiment of the present disclosure;

FIG. 12 is a sequence diagram illustrating an example of operation of displaying information on an interested part on a personal terminal of an organizer, according to an embodiment of the present disclosure;

FIG. 13 is an illustration of an example of an event list display screen, according to an embodiment of the present disclosure;

FIG. 14 is an illustration of an example of an event data display screen, according to an embodiment of the present disclosure;

FIG. 15 is an illustration of an example of an interested part analysis result display screen, according to an embodiment of the present disclosure;

FIG. 16 is an illustration of another example of the interested part analysis result display screen, according to an embodiment of the present disclosure;

FIG. 17 is an illustration of an example of a page information list of a personal memo, according to an embodiment of the present disclosure;

FIG. 18 is a sequence diagram illustrating an example of operation of registering a capture image as a favorite page, according to an embodiment of the present disclosure;

FIG. 19 is a sequence diagram illustrating an example of operation of deregistering a capture image from favorite pages, according to an embodiment of the present disclosure;

FIG. 20A and FIG. 20B are illustrations of examples of user interface buttons for registering and deregistering a favorite page, according to an embodiment of the present disclosure;

FIG. 21 is a sequence diagram illustrating an example of operation of adding a fixed object, according to an embodiment of the present disclosure;

FIG. 22 is a sequence diagram illustrating an example of operation of erasing a fixed object, according to an embodiment of the present disclosure;

FIG. 23 is an illustration of an example of a display screen on which a sticker is added, according to an embodiment of the present disclosure;

FIG. 24 is a sequence diagram illustrating an example of operation of drawing an object, according to an embodiment of the present disclosure;

FIG. 25 is a sequence diagram illustrating an example of operation of erasing an object, according to an embodiment of the present disclosure;

FIG. 26 is an illustration of an example of a display screen when an object is drawn, according to an embodiment of the present disclosure;

FIG. 27 is a flowchart illustrating operation of determining interest for a drawn object, according to an embodiment of the present disclosure;

FIG. 28 is an illustration of another example of a display screen when an object is drawn, according to an embodiment of the present disclosure;

FIG. 29 is a sequence diagram illustrating operation performed when a capture image is viewed, according to an embodiment of the present disclosure;

FIG. 30 is a sequence diagram illustrating operation of analyzing an interested part based on information of a participant's line of sight, according to an embodiment of the present disclosure;

FIG. 31 is a sequence diagram illustrating of operation of designating an area and registering a keyword, according to an embodiment of the present disclosure;

FIG. 32A to FIG. 32D are illustrations of examples of display screens displayed when designating an area and registering a keyword, according to an embodiment of the present disclosure;

FIG. 33 is an illustration for describing how collation between an area and a drawn object is performed, according to an embodiment of the present disclosure;

FIG. 34 is a flowchart illustrating an example of operation of determining a degree of interest, according to an embodiment of the present disclosure;

FIG. 35 is a diagram for describing an example of an area/keyword information management table, according to an embodiment of the present disclosure;

FIG. 36 is diagram for describing an example of a display screen of a list of participants' interests, according to an embodiment of the present disclosure;

FIG. 37 is a flowchart illustrating an example of operation of registering a keyword automatically, according to an embodiment of the present disclosure;

FIG. 38 is a flowchart illustrating another example of operation of registering a keyword automatically, according to an embodiment of the present disclosure;

FIG. 39 is an illustration of an example of a keyword search screen, according to an embodiment of the present disclosure; and

FIG. 40 is an illustration of an example of a keyword list display screen, according to an embodiment of the present disclosure;

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to the drawings, embodiments of the present disclosure are described.

Overview of Information Sharing System:

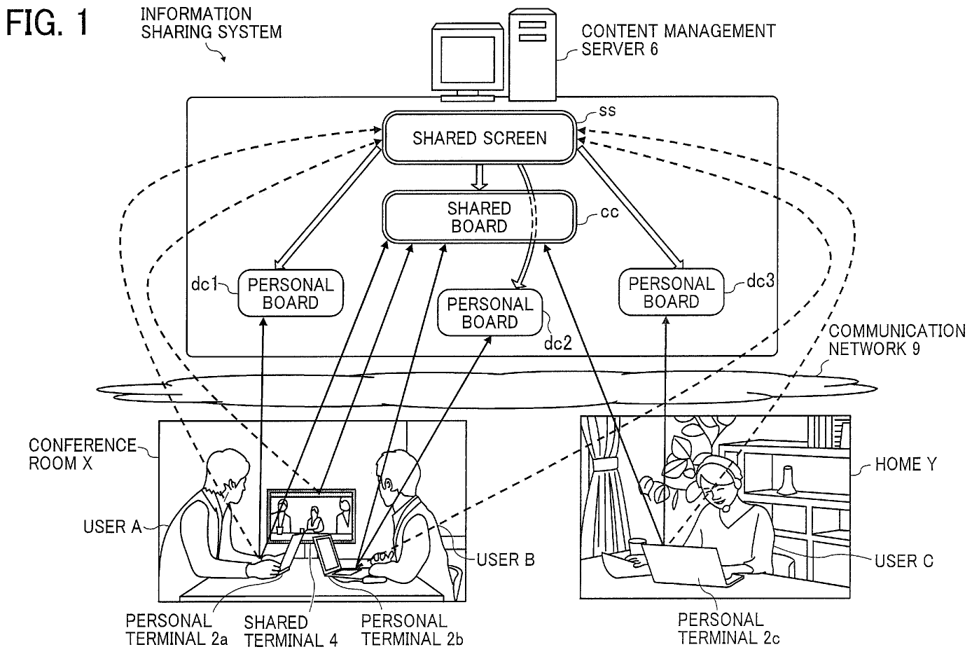

FIG. 1 is a schematic diagram illustrating an overview of an information sharing system, according to an embodiment.

FIG. 1 illustrates a state in which a user A and a user B who are in a meeting room X and a user C who is at a home Y are conducting a remote meeting by using the information sharing system. The user A uses a personal terminal 2a, the user B uses a personal terminal 2b, and the user C uses a personal terminal 2c, to participate in a conference. Further, a shared terminal 4 that can be shared by multiple users is provided in the meeting room X. In the following description, the personal terminal 2a, the personal terminal 2b, and the personal terminal 2c are collectively referred to as simply a “personal terminal 2” or “personal terminals 2”, unless these terminals need to be distinguished from each other.

The present embodiment is applicable to various information sharing systems used for any event in which multiple persons participate, such as seminars, lectures, classes, or product presentations, in addition to conferences. In one example, participants gathering at the same place participate in a conference. In another example, participants participate in a conference from different places. In the present embodiment, a description is given of an example in which a teleconference is conducted including the user C who is connected through a network. However, in another example, the users A, B, and C are be in the same room. In other words, the users do not have to be in remote locations.

The personal terminal 2 is an example of a communication terminal. The personal terminal is a communication terminal that a user can use individually and whose screen is viewed by the user individually. The personal terminal 2 is not limited to being privately-owned. The personal terminal 2 may be public, private, non-profit, rental or any other type of ownership terminal in which a user may individually or exclusively use the terminal and whose screen is viewed by the user individually. Examples of the personal terminal 2 include a laptop computer, a desktop personal computer (PC), a mobile phone, a smartphone, a tablet terminal, and a wearable PC.

The shared terminal 4 is an example of an information processing terminal. The shared terminal is an information processing terminal that a plurality of users can jointly use or share and whose screen is vied by the plurality of users. Examples of the shared terminal 4 includes a projector (PJ), an interactive whiteboard (IWB), a digital signage, a display to which a stick PC is connected. The IWB is a whiteboard having an electronic whiteboard function having mutual communication capability. In one embodiment, the shared terminal 4 is omitted. In other words, in one embodiment, the information sharing system does not include the shared terminal 4.

Each of the personal terminals 2 and the shared terminal 4 is communicable with a content management server 6 through a communication network 9 such as the Internet. The communication network 9 is, for example, one or more local area networks (LANs) inside the firewall. In another example, the communication network 9 includes the Internet that is outside the firewall in addition to the LAN. In still another example, the communication network 9 further includes a virtual private network (VPN) and/or a wide-area Ethernet (registered trademark).

The communication network 9 is any one of a wired network and a wireless network. In another example, the communication network 9 is a combination of the wired network and the wireless network. In a case where the content management server 6, the personal terminal 2, and the shared terminal 4 connects to the communication network 9 through a mobile phone network such as 3G, Long Term Evolution (LTE), 4G, or 5G, the LAN can be omitted.

The content management server 6 is an example of an information processing apparatus. The content management server 6 is an information processing functioning as a web server (or an HTTP server) that stores and manages data of contents to be transmitted to the personal terminal 2 and the shared terminal 4.

The content management server 6 includes a storage unit 66 described below. The storage unit 66 includes storage areas for implementing a personal board dc1, a personal board dc2, and a personal board dc3.

Only the personal terminal 2a can access the personal board dc1. Further, only the personal terminal 2a can access the personal board dc2. Furthermore, only the personal terminal 2c can access the personal board dc3. In the following description, the personal board dc1, the personal board dc2, and the personal board dc3 are collectively referred to as simply a “personal board dc” or “personal boards dc”, unless these boards need to be distinguished from each other.

In one example, the content management server 6 supports cloud computing. The term “cloud computing” refers to Internet-based computing where resources on a network are used or accessed without identifying specific hardware resources.

The storage unit 66 of the content management server 6 further includes a storage area for implementing a shared board cc that is accessible from the personal terminals 2. The storage unit 66 further includes a storage area for implementing a shared screen ss that is accessible from the personal terminals 2.

The personal board dc and the shared board cc are virtual spaces each being generated in the storage area in the storage unit 66 of the content management server 6. For example, the personal board dc and the shared board are accessible by using a web application having a function of allowing a user to view and edit contents with the Canvas element and JavaScript (registered trademark).

The term “web application” refers to software or a mechanism of software used on a web browser application (referred to as a “web browser” in the following description). The web application is implemented by a program written in a script language such as JavaScript (registered trademark) that operates on the web browser and a program on a web server side, which operate in cooperation with each other.

Each of the personal board dc and the shared board cc has a finite or an infinite area within the range of the storage area in the storage unit 66. For example, each of the personal board dc and the shared board cc is finite or infinite both in the vertical and horizontal directions. In another example, each of the personal board dc and the shared board cc is finite or infinite in either the vertical direction or the horizontal direction.

The shared screen ss is a virtual space generated in the storage area in the storage unit 66 of the content management server 6. In contrast with the personal board dc and the shared board cc, the shared screen ss stores data of contents to be transmitted to the personal terminals 2 and the shared terminal 4. The shared screen ss has a function of storing the previous content until the next content is acquired. The shared screen ss is accessed by a web application having a function of allowing a user to view contents.

The personal board dc is an electronic space dedicated to each of the users. The personal terminal 2 of each user can access only the personal board dc dedicated to the corresponding user, which allows the corresponding user to view and edit (input, delete, copy, etc.) contents such as characters and images on the accessed personal board.

The shared board cc is an electronic space shared by the users. Any of the personal terminals 2 of the users can access the shared board cc, allowing the users to view and edit contents such as characters and images on the shared board cc.

The shared screen ss is an electronic space shared by the users. Any of the personal terminals 2 of the users can access the shared screen ss, allowing the users to view the shared screen ss. In other words, the personal terminals 2 included in the information sharing system share the shared screen ss.

For example, when the personal terminal 2a transmits data of contents to the shared screen ss and thereafter the personal terminal 2b transmits data of contents to the shared screen ss, the content data stored by the shared screen ss is updated to the data of contents most recently, i.e., the data of contents received from the personal terminal 2b. For example, a computer screen such as an application screen shared by the users is displayed on the shared screen ss.

The content management server 6 stores, for each virtual conference room, information (data) such as contents developed on the shared screen ss, the shared board cc, and the personal board dc in association with the corresponding virtual conference room. The virtual conference room is an example of a virtual room. In the following description, the virtual conference room is referred to as a “room”, in order to simplify the description. Thereby, even when the content management server 6 manages multiple rooms, data of contents are not communicated over different rooms.

Each personal terminal 2 causes the web application operating on the web browser installed in the personal terminal 2 to display the contents of the personal board dc, the shared board cc, and the shared screen ss of the room in which the user participates. Thus, the meeting is held in a manner that is close to a meeting held in a real conference room.

The information sharing system having the configuration as described above allows the user to open the user's personal file with an application and share a screen of the opened file on the shared screen ss, and/or to share handwritten strokes or characters or object arrangement on the shared board cc. The information sharing system further allows the user to keep handwritten strokes or characters or object arrangement on the personal board dc as a personal memo.

Overview of Personal Portal of Information Sharing System:

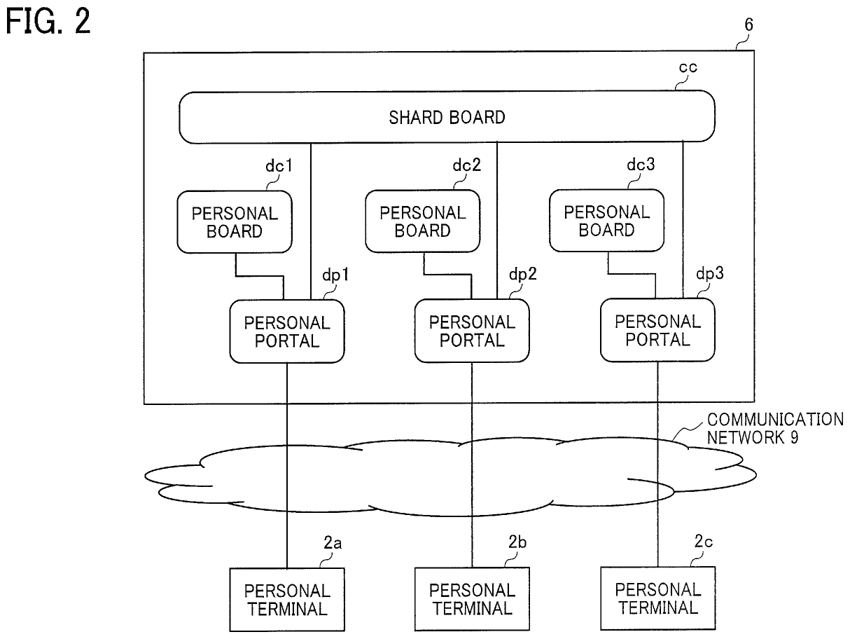

FIG. 2 is a schematic diagram illustrating an overview of a personal portal of the information sharing system, according to an embodiment.

The content management server 6 generates data for a personal portal dp1, a personal portal dp2, and a personal portal dp3 for the personal terminal 2a, the personal terminal 2b, and the personal terminal 2c, respectively. Further, the content management server 6 causes the personal terminal 2a, the personal terminal 2b, and the personal terminal 2c to display screens of the personal portal dp1, the personal portal dp2, and the personal portal dp3, respectively, based on the generated data. In the following description, the personal portal dp1, the personal portal dp2, and the personal portal dp3 are collectively referred to a simply a “personal portal dp” or “personal portals dp”, unless these portals need to be distinguished from each other.

The content management server 6 stores and manages the shared board cc and the personal boards dc. Each user accesses the personal portal dp of each personal terminal 2, to cause a list of meetings in which the user who operates the corresponding personal terminal 2 has participated to be displayed.

Each user causes the shared board cc, the personal board dc, and the personal memo dm of each meeting and reference information of the meeting to be displayed from a list of meetings displayed on the personal portal dp. A detailed description is given below of the above processing. This enables a user, for example, when the user wants to look back contents of meetings, to view the shared board cc, the personal board dc of a desired meeting and the reference information of the desired meeting with simple operation.

Further, each user accesses the personal portal dp of each personal terminal 2, to search a list of the meetings of the user operating the corresponding personal terminal 2 for a desired meeting by using a keyword. A detailed description is given below of the above processing. For example, the reference information of the meeting, text data and handwritten characters included in the personal board dc, and the evaluation of the meeting by the user are searched through by using a keyword. The reference information of the meeting is included in the meeting information.

Hardware Configuration of Communication Terminal:

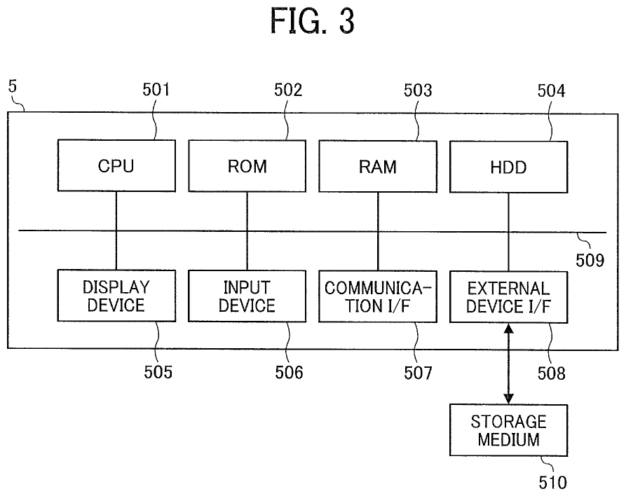

FIG. 3 is a diagram illustrating an example of a hardware configuration, according to the present embodiment.

Each of the personal terminal 2, the shared terminal 4, and the content management server 6 is implemented by a computer 5 having a hardware configuration as illustrated in FIG. 3.

The computer 5 includes a central processing unit (CPU) 501, a read only memory (ROM) 502, a random access memory (RAM) 503, a hard disk drive (HDD) 504, a display device 505, an input device 506, a communication interface (I/F) 507, an external device I/F 508, and a data bus 509.

The CPU 501 controls overall operation of each of the personal terminal 2, the shared terminal 4, and the content management server 6. The CPU 501 reads programs and data stored in the ROM 502 and the HDD 504 from the ROM 502 and the HDD 504 to the RAM 503 and executes the processing according to the read programs and data.

The ROM 502 is a nonvolatile semiconductor memory that stores programs and data such as a basic input/output system (BIOS), operating system (OS) settings or network settings. The RAM 503 is a volatile semiconductor memory that temporarily stores programs and data. The HDD 504 is a nonvolatile storage device that stores programs and data such as an OS or applications.

The display device 505 includes, for example, a display, and displays various information such as a cursor, a menu, a window, a character, or an image, and processing results. The input device 506 includes, for example, a keyboard, a mouse, and a touch panel, and receives input from the user.

The communication I/F 507 is an interface that controls communication of data through the communication network 9. The external device I/F 508 is an interface that connects the computer to an external device. Examples of the external device include a photographing device such as a camera, a recording device, and a recording medium such as a storage medium 510. Examples of the storage medium 510 include a flexible disk, a compact disc (CD), a digital versatile disc (DVD), a secure digital (SD) memory card, and a universal serial bus (USB) memory. Examples of the data bus 509 include an address bus and a data bus that electrically connect the components, such as the CPU 501, with one another.

Functional Configuration:

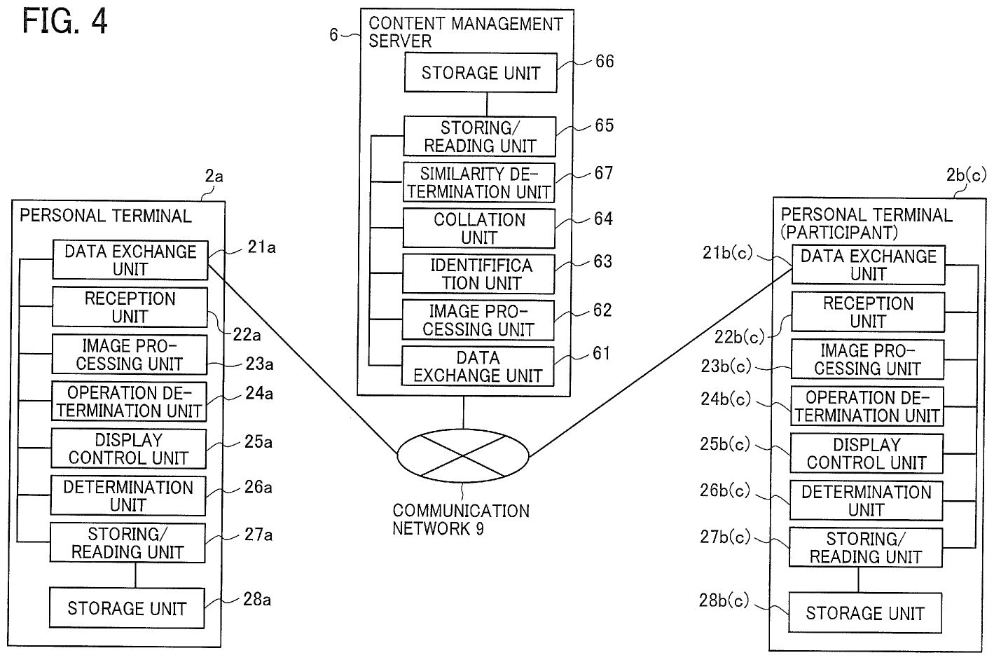

FIG. 4 is a block diagram illustrating an example of a functional configuration of the information sharing system, according to the present embodiment.

Functional Configuration of Personal Terminal:

The personal terminal 2a is an example of a first communication terminal. In this example, the personal terminal 2a is a communication terminal used by an organizer of an event. The personal terminal 2a includes a data exchange unit 21a, a reception unit 22a, an image processing unit 23a, an operation determination unit 24a, a display control unit 25a, a determination unit 26a, and a storing/reading unit 27a.

These units are functions or means implemented by or that are caused to function by operating any of the hardware components illustrated in FIG. 3 in cooperation with instructions of the CPU 501 according to the program expanded to the RAM 503.

The personal terminal 2a further includes a storage unit 28a, which is implemented by, for example, the ROM 502 or the HDD 504 illustrated in FIG. 3. The storage unit 28a mainly stores information on the personal memo and a shared memo.

A description is now given of the detail of each functional unit of the personal terminal 2a.

The data exchange unit 21a is implemented mainly by the communication I/F 507, when operating according to instructions of the CPU 501. The data exchange unit 21a enables the personal terminal 2a to communicate with the content management server 6 through the communication network 9.

The data exchange unit 21a transmits to the content management server 6 information corresponding to requests from the user received by the reception unit 22a, and receives information transmitted from the content management server 6. The data exchange unit 21a is an example of transmission means. The data exchange unit 21a is also an example of reception means.

The reception unit 22a is implemented mainly by the input device 506, when operating according to instructions of the CPU 501. The reception unit 22a receives user input to the input device 506. The reception unit 22a is an example of acceptance means.

The image processing unit 23a is mainly implemented by instructions of the CPU 501. The image processing unit 23a performs processing such as generating vector data (or stroke data) according to drawing of an object by the user, for example. The image processing unit 23a has a function as a capturing unit. For example, the image processing unit 23a has a function of shooting a capture of the shared screen ss.

The operation determination unit 24a is mainly implemented by instructions of the CPU 501. The operation determination unit 24a of the personal terminal 2a determines a content of an operation performed by the organizer, when the organizer performs an operation such as object drawing for designating an area described below.

The display control unit 25a is mainly implemented by the display device 505, when operating according to instructions of the CPU 501. The display control unit 25a controls the display device 505 displays various display screens such as the personal board and the shared board described below. The display control unit 25a is an example of display control means.

The determination unit 26a, which is mainly implemented by instructions of the CPU 501, performs various determinations.

The storing/reading unit 27a is implement by instructions of the CPU 501. The storing/reading unit 27a stores data in the storage unit 28a and reads out data from the storage unit 28a.

Each of the personal terminal 2b and the personal terminal 2c has substantially the same functional configuration as that of personal terminal 2a described above. Accordingly, following describes details of differences from the personal terminal 2a.

Each of the personal terminal 2b and the personal terminal 2c is an example of a second communication terminal. In this example, each of the personal terminal 2b and the personal terminal 2c is a communication terminal used by a participant participating in an event.

Each of an operation determination unit 24b of the personal terminal 2b and an operation determination unit 24c of the personal terminal 2c is mainly implemented by instructions of the CPU 501. The operation determination unit 24b of the personal terminal 2b determines a content of an operation performed by a participant when the participant performs an operation on a capture image captured by the personal terminals 2b. In substantially the same manner, the operation determination unit 24c of the personal terminal 2c determines a content of an operation performed by a participant when the participant performs an operation on a capture image captured by the personal terminals 2c. Examples of the operation performed by the participant include an operation of registering a desired capture image as a favorite page, an operation of adding a fixed object such as a sticker to a capture image, an operation of drawing an object on a capture image, and an operation of viewing a capture image.

Functional Configuration of Content Management Server:

A description is now given of an example of a functional configuration of the content management server 6.

The content management server 6 is an example of an information processing apparatus. The content management server 6 includes a data exchange unit 61, an image processing unit 62, an identification unit 63, a collation unit 64, a storing/reading unit 65, and a similarity determination unit 67.

These units are functions or means implemented by or that are caused to function by operating any of the hardware components illustrated in FIG. 3 in cooperation with instructions of the CPU 501 according to the program expanded to the RAM 503.

The content management server 6 further includes a storage unit 66, which is implemented by, for example, the ROM 502 and the HDD 504 illustrated in FIG. 3. The storage unit 66 mainly stores information on a personal memo, a shared memo, a collation area, and a search keyword.

A description is now given of the detail of each functional unit of the content management server 6.

The data exchange unit 61 is mainly implemented by the communication I/F 507, when operating according to instructions of the CPU 501. The data exchange unit 61 allows the content management server to communicate with the personal terminals 2 through the communication network 9. The data exchange unit 61 receives, for example, information transmitted from the personal terminal 2b, and transmits image information identified by the identification unit 63 to the personal terminal 2a. The data exchange unit 61 is an example of transmission means. The data exchange unit 61 is also an example of reception means.

The image processing unit 62 is mainly implemented by instructions of the CPU 501. The image processing unit 62 performs capturing processing described below of the shared screen at the personal terminal 2 and creates a content identifier (ID), which is unique, a personal memo ID, shared memo ID, for example.

The identification unit 63 is mainly implemented by instructions of the CPU 501. The identification unit 63 identifies a part where an operation is performed on the capture image by the personal terminal 2 based on the information received by the data exchange unit 61. The identification unit 63 is an example of identification means.

The collation unit 64 is mainly implemented by instructions of the CPU 501. The collation unit 64 collates, for a particular capture image, a part where an operation is performed by the personal terminal 2a and a part where an operation is performed by the personal terminal 2b and the personal terminal 2c. The collation unit 64 is an example of collation means.

The storing/reading unit 65 is mainly implemented by instructions of the CPU 501. The storing/reading unit 65 stores data in the storage unit 66 and reads out data from the storage unit 66. In another example, these data are stored in any suitable server other than the content management server 6. In this case, the data may be acquired and transmitted from other server each time the personal terminal 2 sends a request for data acquisition and transmission. In another example, these data are stored in the content management server 6 during the event or while the personal board dc or the shared board is referenced by the user, and the data are deleted from the content management server 6 and sent to other server after the end of the event or the reference (or after a certain period of time).

The similarity determination unit 67 is implemented mainly by instructions of the CPU 501. The similarity determination unit 67 determines similarity of images in capture images stored in the storage unit 66, to perform processing of removing the same page when the same page is captured a plurality of times.

Personal Board:

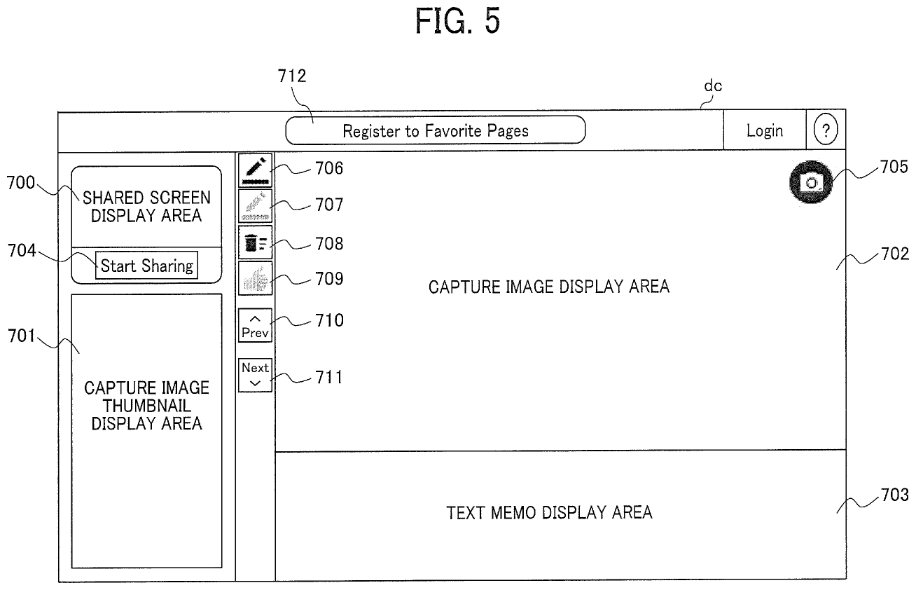

A description is now given of an example of a display screen of the personal board with reference to FIG. 5 to FIG. 7.

FIG. 5 is an illustration of an example of a screen layout of the personal board dc.

This example illustrates a screen of the personal board dc displayed on the display device 505 of the personal terminal 2. Each of the display control unit 25a of the personal terminal 2a, the display control unit 25b of the personal terminal 2b, and the display control unit 25c of the personal terminal 2c controls the display device 505 to display a screen of the personal board dc corresponding to application information transmitted from the content management server 6.

The personal board dc is an example of a screen displayed on the display device 505 when personal board information is received from the content management server 6, for example. The personal board dc includes a shared screen display area 700, a capture image thumbnail display area 701, a capture image display area 702, and a text memo display area 703.

The shared screen display area 700 displays the shared screen ss illustrated in FIG. 1. The capture image display area 702 displays a capture image captured from the shared screen display area 700.

The capture image thumbnail display area 701 displays a list of capture images captured to the personal terminal 2 by the user of the personal terminal during the event. The text memo display area 703 displays a text memo attached the capture image.

The shared screen display area 700 includes a sharing start button 704. The sharing start button 704 is a button used by a user as a source of sharing. In response to pressing of the sharing start button 704 by the user as the source of sharing, the display control unit 25a of the personal terminal 2a displays the shared screen displayed on the shared screen display area 700 of the personal terminal 2a on the shared screen display area 700 of each of the personal terminal 2b and the personal terminal 2c. Thus, the shared screen is shared among the personal terminal 2a, the personal terminal 2b, and the personal terminal 2c.

The capture image display area 702 includes a capture button 705. The user of the personal terminal 2 performs an operation of pressing the capture button 705 to capture the shared screen displayed on the shared screen display area 700 to the capture image display area 702. In response to the operation of pressing the capture button 705 by the user of the personal terminal 2, the image processing unit 23 of the personal terminal shoots a capture of the shared screen displayed on the shared screen display area 700 to acquire a capture image. Thus, the display control unit 25 of the personal terminal 2 displays the capture image in the capture image display area 702.

The display screen of the personal board dc further includes various buttons near the capture image display area 702. In the present embodiment, the display screen of the personal board dc includes, for example, a black pen button 706, a red pen button 707, an eraser button 708, a sticker button 709, a page back button 710, a page forward button 711, and a favorite setting button 712.

The black pen button 706 and the red pen button 707 are used by the user to draw (write) an object on the capture image displayed in the capture image display area 702.

The eraser button 708 is used to erase an object created on the capture image by the black pen button 706, the red pen button 707, and the sticker button 709.

The sticker button 709 is used to add a fixed object to the capture image displayed in the capture image display area 702. In this example, the term “fixed object” refers to, for example, a sticker including text such as “like” or a graphic sticker such as a circle, a quadrangle, a triangle, an arrow, and other marks. The sticker or the graphic sticker is merely one example of the fixed object, and in another example, the fixed object includes an object that is prepared in advance.

The page back button 710 and the page forward button 711 are used to scroll a list of capture images displayed in the capture image thumbnail display area 701.

The favorite setting button 712 is used to register the capture image displayed in the capture image display area 702 as a favorite page.

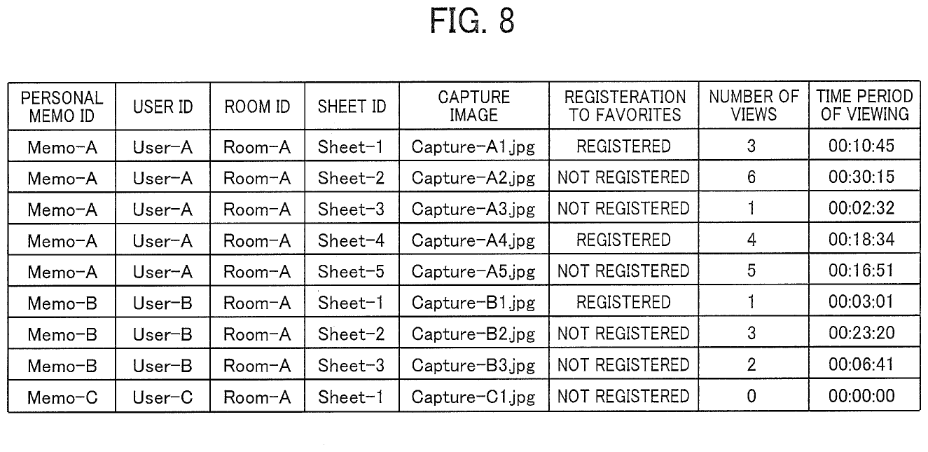

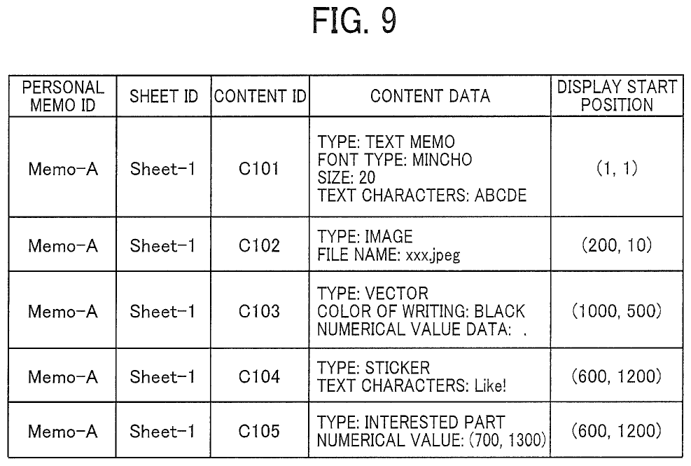

The user of the personal terminal 2 writes a memo in the text memo display area 703. The memo input to the text memo display area 703 is stored as a personal memo management database (DB) and a personal memo DB in the storage unit 66 of the content management server 6 in association with the capture image displayed in the capture image display area 702. A detailed description is given below of the personal memo management DB and the personal memo DB with reference to FIG. 8 and FIG. 9.

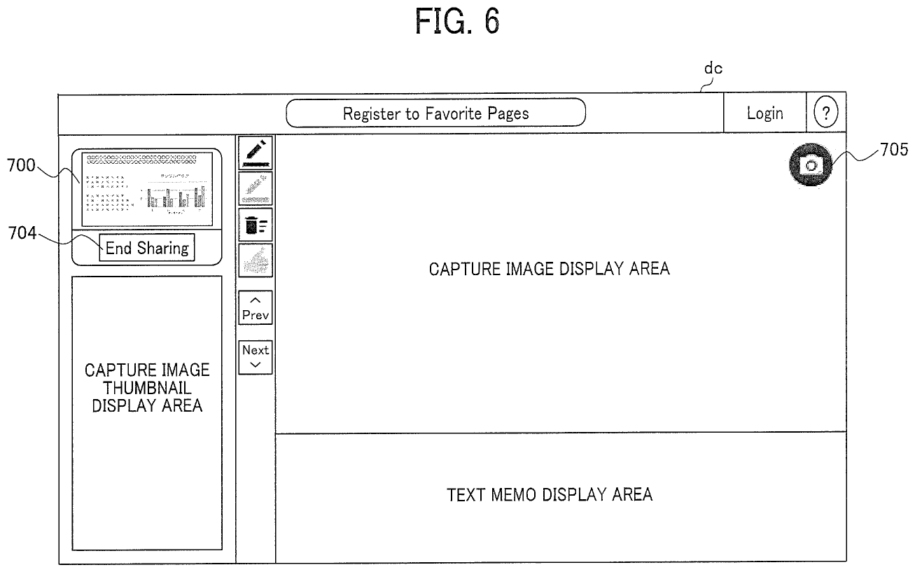

In a state in which the personal board dc as illustrated in FIG. 5 is displayed, when the user (for example, the organizer of the event) as the source of sharing of the shared screen performs an operation of pressing the sharing start button 704 on the personal board dc, the screen transitions to a screen as illustrated in FIG. 6.

FIG. 6 is an illustration of an example of a screen on which a shared screen is displayed in the shared screen display area 700.

The shared image is displayed in the shared screen display area 700 of the personal terminal 2. This enables the organizer and the participants of the event to view the shared image in the shared screen display area 700 of personal terminal 2.

Text displayed in the sharing start button 704 switches in response to the display of shared image in the shared screen display area 700. Specifically, before the shared image is displayed in the shared screen display area 700, text “Start Sharing” is displayed as illustrated in FIG. 5. By contrast, the shared image is displayed in the shared screen display area 700 in response to the pressing of the sharing start button 704, the displayed text is switched to “End Sharing” as illustrated in FIG. 6.

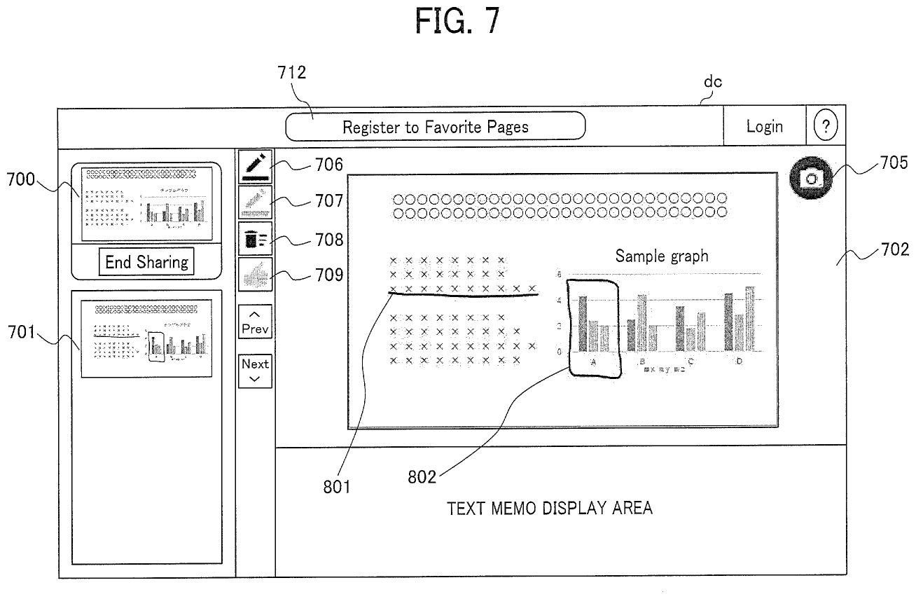

When the capture button 705 is pressed in the state as illustrated in FIG. 6, the display screen of the personal board dc transitions to a screen as illustrated in FIG. 7.

FIG. 7 is an illustration of an example of a screen on which a capture image is displayed in the capture image display area 702.

When the operation of pressing the capture button 705 is performed in the state as illustrated in FIG. 6, the shared image displayed in the shared screen display area 700 is captured and displayed in the capture image display area 702 of the personal board dc of the participant participating in the event. Further, the same image as the image displayed in the capture image display area 702 is also displayed in the capture image thumbnail display area 701.

In the capture image captured to the capture image display area 702, the user can draw an object such as drawing an underline 801 or drawing a FIG. 802 at a part to which the participant pays attention by using a pen tool (e.g., the black pen button 706 and the red pen button 707) as illustrated in FIG. 7.

The object drawn in the capture image can be erased with an eraser tool (e.g., the eraser button 708).

The participant can also add a sticker on the capture image with the sticker button 709. Further, the participant can register the capture image displayed in the capture image display area 702 as a favorite page with the favorite setting button 712. A detailed description is given below of the setting of favorites.

DB Structure: Personal Memo Management DB:

FIG. 8 is diagram for describing an example of a personal memo management information table in the personal memo management DB.

The personal memo management information table is a table included in the personal memo management DB. The personal memo management DB is stored in the storage unit 66 of the content management server 6 illustrated in FIG. 4. The storage unit 66 stores the personal memo management information table as illustrated in FIG. 8.

The registration of information in the personal memo management DB is performed in synchronization with a timing at which the shared image is captured to the capture image display area 702 of the personal board dc. In another example, the registration is performed before or after such timing.

The personal memo management information table included in the personal memo management DB stores a personal memo ID, a user ID, a room ID, a sheet ID, a capture image, registration to favorites, the number of views, a time period of viewing in association with one another.

The personal memo ID is an example of personal memo identification information identifying a personal board dc. The user ID is an example of user identification information identifying a user of the personal terminal 2. The room ID is an example of room identification information identifying a location where an event is held. The sheet ID is an example of sheet identification information identifying a sheet. The capture image is an example of image file identification information identifying an image file for which shooting of a capture is performed. The registration to favorites, the number of views, and the time period of viewing are updated each time the user registers a capture image captured by the personal terminal 2 to favorite pages or views the capture image.

For example, when the user ID of the user who operates the personal terminal 2 is identified, the storing/reading unit 65 of the content management server 6 searches the personal memo management information table using the room ID or a personal memo ID as a search key, to retrieve an event in which the user participated. When the event in which the user participated is identified, the identification unit 63 of the content management server 6 identifies a capture image captured by the user, information indicating whether the capture image is registered as a favorite page, for example.

Personal Memo DB:

FIG. 9 is diagram for describing an example of a personal memo information table in the personal memo DB.

The personal memo information table is a table included in the personal memo DB. The personal memo DB is also stored in the storage unit 66 of the content management server 6 illustrated in FIG. 4. The storage unit 66 stores the personal memo information table as illustrated in FIG. 9.

The personal memo information table included in the personal memo DB stores a personal memo ID, a sheet ID, a content ID, content data, and a display start position in association with one another.

The personal memo ID is an example of personal memo identification information identifying a personal board dc. The sheet ID is an example of sheet identification information identifying a sheet. The content ID is an example of content identification information identifying each content of an operation (e.g., drawing of an object, writing of a memo) performed by the user on the capture image captured to the personal terminal 2.

The content data is detailed data of an operation (e.g., drawing of an object, writing of a memo) performed by the user on the capture image captured to the personal terminal 2. The display start position is coordinate data identifying a start point position of an object displayed on the capture image.

FIG. 9 illustrates an example in which five operations identified respectively by content IDs “C101” to “C105” are performed in a material of one page identified by a sheet ID “Sheet-1”. For example, content data identified by the content ID “C101” has a type “text memo”, a font type “Mincho”, a size “20”, and text characters “ABCDE”.

This indicates that the character string “ABCDE” input with the Mincho font having a font size of 20 points is present at a position whose start point is coordinates (1, 1) on the capture image.

The content ID “C102” indicates that an image exists at a position whose start point is coordinates (200, 10) on the capture image. Content data identified by the content ID “C103” has a type “vector” and a drawing color “black”. This indicates that an object drawn using a pen tool (e.g., the black pen button 706) provided on the personal board dc is present at a position whose start point is coordinates (1000, 500) on the capture image.

Content data identified by the content ID “C104” has a type “sticker” and text characters “like!”. This indicates that a fixed object added using a sticker tool (e.g., the sticker button 709) provided on the personal board dc is present at a position whose start point is coordinate (600, 1200) on the capture image.

Content data identified by the content ID “C105” has a type “interested part” and a numerical value “700, 1300”. This indicates that a rectangular area is present whose start point is coordinates (600, 1200) and end point is coordinates (700, 1300) on the capture image.

This rectangular area is extracted by the identification unit 63 of the content management server 6 as described below, and the extraction result is stored in the personal memo information table. Although the description given above is of an example in which data of two points on a diagonal line are used as the coordinates of the rectangular area, this is merely one example. The coordinate data can be obtained in any other form, provided that the rectangular area is defined.

For example, when a personal memo ID is identified, the storing/reading unit 65 of the content management server 6 searches the persona memo information table using the sheet ID as a search key, to retrieve a capture image captured by the user to the personal terminal 2. When the capture image is identified, the identification unit 63 of the content management server 6 identifies detailed contents of an operation (e.g., drawing of an object, writing of a memo) performed by the user on the capture image based on the content ID and the content data.

Sequence: Sequence of Operation of Displaying Shared Screen on Personal Board:

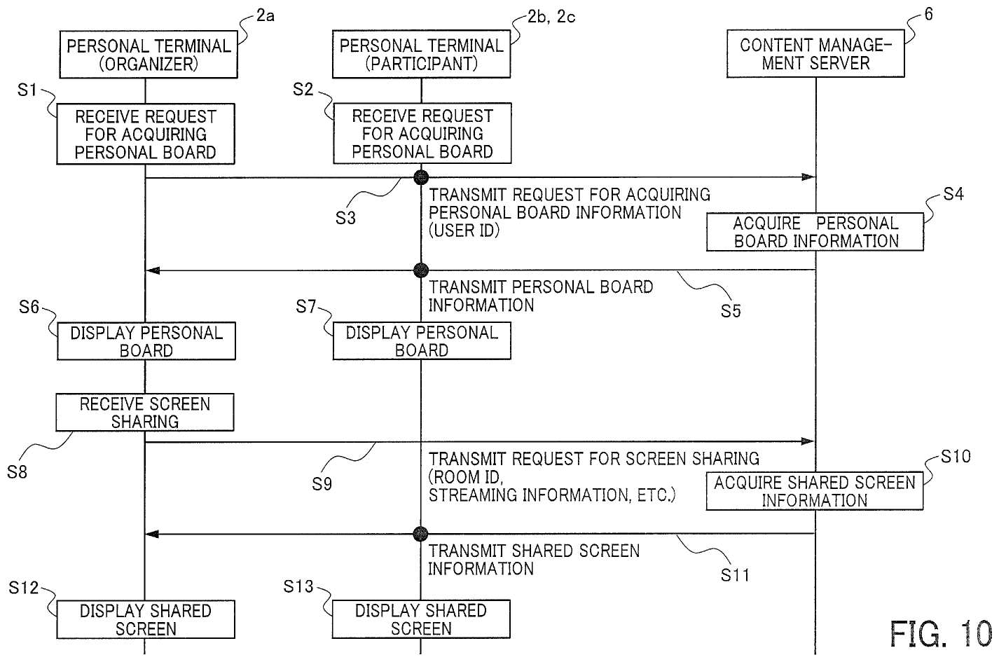

FIG. 10 is a sequence diagram illustrating an example of operation of displaying the shared screen ss on the personal board dc.

First, the display control unit 25a of the personal terminal 2a controls the display device 505 to display a virtual room in which an event is to be held in response to, for example, a predetermined input operation to the input device 506 by the user. In the following description, the user of the personal terminal 2a is referred to as an “organizer”. Further, in the following description, the virtual room is referred to as a “room”, to simplify the description. The organizer instructs acquisition of the personal board dc1 on the screen of the room displayed on the display device 505 using the input device 506.

In response to the input of the instruction to acquire the personal board dc1 from the organizer, the reception unit 22a of the personal terminal 2a receives the instruction to acquire the personal board dc1 (step S1).

Further, each of the display control unit 25b of the personal terminal 2b and the display control unit 25c of the personal terminal 2c controls the display device 505 to display a room in response to, for example, a predetermined input operation to the input device 506 by the user. In the following description, each of the user of the personal terminal 2b and the user of the personal terminal 2c is referred to as a “participant”. The participants instruct acquisition of the personal board dc2 and the personal board dc3 respectively on the screen of the room displayed on the display device 505 using the input device 506. In response to the input of the instruction to acquire the personal board dc2 and the personal board dc3 from the participants respectively, the reception unit 22b of the personal terminal 2b and the reception unit 22c of the personal terminal 2c receive the instruction to acquire the personal board dc2 and the personal board dc3 respectively (step S2).

In response to receiving the instruction to acquire the personal board dc by the reception unit 22 of each personal terminal 2, the data exchange unit 21 of each personal terminal 2 transmits a request to acquire personal board information to the content management server 6 (step S3).

The request to acquire personal board information includes a user ID identifying each personal terminal 2. Thus, the data exchange unit 61 of the content management server 6 receives the request to acquire personal board information transmitted from each personal terminal 2.

Next, the storing/reading unit 65 of the content management server 6 reads the personal board dc stored in the storage unit 66. Each user ID received in step S3 is assigned to the personal board dc read from the storage unit 66, and the personal board dc is stored in the storage unit 66 in a manner that one user ID corresponds to one personal board dc. Thus, the storing/reading unit 65 acquires personal board information in which the received user ID and the personal board dc are associated with each other (step S4).

Next, the data exchange unit 61 of the content management server 6 transmits the personal board information acquired in step S4 to each of the personal terminals 2 (step S5). The data exchange unit 21 of each of the personal terminals 2 receives the personal board information transmitted from the content management server 6.

Next, the display control unit 25a of the personal terminal 2a controls the display device 505 to display a screen of the personal board based on the personal board information received in step S5 (step S6).

In substantially the same manner, each of the display control unit 25b of the personal terminal 2b and the display control unit 25c of the personal terminal 2c controls the display device 505 to display a screen of the personal board based on the personal board information received in step S5 (step S7). For example, the screen of the personal board dc as illustrated in FIG. 5 is displayed in step S6 and step S7.

Next, the organizer designates an image to be shared with the participants on the shared screen ss and the shared screen display area 700 of the personal board dc. The designation of the image to be shared is performed by reading data stored in, for example, the storage unit 28a of the personal terminal 2a by the storing/reading unit 27a.

The organizer who has designated a document to be shared with the participants presses the sharing start button 704 illustrated in FIG. 5 on the screen of the personal board dc1. In response to the pressing of the sharing start button 704 by the organizer, the reception unit 22a of the personal terminal 2a receives screen sharing (step S8).

When the reception unit 22a of the personal terminal 2a receives the screen sharing, the data exchange unit 21a of the personal terminal 2a transmits a request for screen sharing to the content management server 6 (step S9).

The request for screen sharing includes information such as a room ID identifying a location where the event is held and a sheet ID identifying a document distributed in the event. Thus, the data exchange unit 61 of the content management server 6 receives the request for screen sharing transmitted from the personal terminal 2a.

In step S9, the personal terminal 2a designates the room ID and transmits a streaming to be transmitted to the shared screen ss of a particular room by Web Real-Time Communication (WebRTC). WebRTC is a standard that implements high-speed data communication via a web browser. WebRTC is one of Application Programming Interfaces (APIs) of HyperText Markup Language (HTML). WebRTC enables an exchange of large-volume data such as video and audio in real time.

In response to receiving the request for screen sharing, the storing/reading unit 65 of the content management server 6 reads information of the personal board dc2 of the personal terminal 2b and the personal board dc3 of the personal terminal 2c associated with the room ID from the storage unit 66 of the content management server 6. Thus, the content management server 6 acquires shared screen information in which the information of the personal board dc2 and the personal board dc3 read from the storage unit 66 and the streaming information received from the personal terminal 2a are associated with each other (step S10).

Next, the data exchange unit 61 of the content management server 6 transmits the shared screen information acquired in step S10 to each of the personal terminals 2 (step S11). Thus, the data exchange unit 21 of each of the personal terminals 2 receives the shared screen information transmitted from the content management server 6.

Next, the display control unit 25a of the personal terminal 2a controls the display device 505 to display a shared screen based on the shared screen information received in step S11 (step S12). In substantially the same manner, each of the display control unit 25b of the personal terminal 2b and the display control unit 25c of the personal terminal 2c controls the display device 505 to display the shared screen based on the shared screen information received in step S11 (step S13). For example, the screen of the personal board dc as illustrated in FIG. 6 is displayed in step 12 and step 13.

Sequence of Operation of Displaying Capture Image:

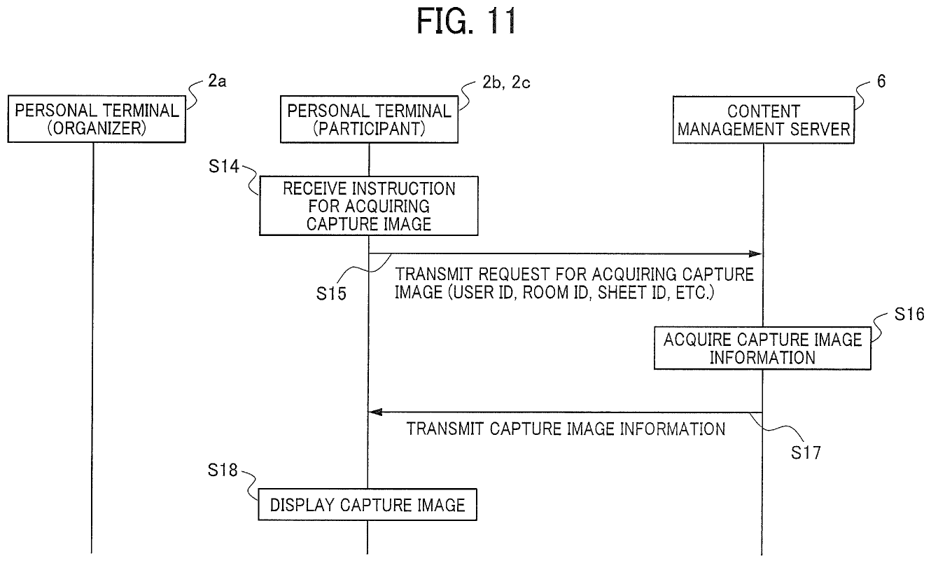

FIG. 11 is a sequence diagram illustrating an example of operation of displaying a capture image on the personal board dc.

The operation of this sequence diagram is performed when a participant is interested in a particular part in the shared screen displayed on the shared screen display area 700 of the personal board dc and the participant captures the shared screen to the personal terminal 2 of the participant as a capture image.

In this case, the participant presses the capture button 705 illustrated in FIG. 6 provided in the capture image display area 702 of the personal board dc. In response to the pressing of the capture button 705 by the participant, each of the reception unit 22b of the personal terminal 2b and the reception unit 22c of the personal terminal 2c receives an instruction for acquiring a capture image (step S14).

When each of the reception unit 22b of the personal terminal 2b and the reception unit 22c of the personal terminal 2c receives the instruction for acquiring the capture image, each of the data exchange unit 21b of the personal terminal 2b and the data exchange unit 21c of the personal terminal 2c transmits a request to acquire the capture image to the content management server 6 (step S15).

The request to acquire the capture image includes information such as a user ID identifying the user (participant), a room ID identifying a location where the event is held, and a sheet ID identifying an acquisition target of the capture image. Thus, the data exchange unit 61 of the content management server 6 receives the request to acquire the capture image transmitted from each of the personal terminal 2b and the personal terminal 2c.

In response to receiving the request to acquire the capture image, the image processing unit 62 of the content management server 6 shoots a capture of an image associated with the sheet ID, to acquire capture image information (step S16).

Next, the data exchange unit 61 of the content management server 6 transmits the capture image information acquired in step S16 to the personal terminal 2b and the personal terminal 2c (step S17). Thus, each of the data exchange unit 21b of the personal terminal 2b and the data exchange unit 21c of the personal terminal 2c receives the capture image information transmitted from the content management server 6.

Next, each of the display control unit 25b of the personal terminal 2b and the display control unit 25c of the personal terminal 2c controls the display device 505 to display a capture screen based on the capture image information received in step S17 (step S18).

For example, the screen of the personal board dc as illustrated in FIG. 7 is displayed in step 18. Although the description given above is of an example in which the image processing unit 62 of the content management server 6 shoots a capture, in another example, each of the image processing unit 23b of the personal terminal 2b and the image processing unit 23c of the personal terminal 2c shoots a capture. For example, in a case in which the personal terminal 2c shoots a capture of the shared screen, an image file of the capture image is transmitted from the personal terminal 2c to the content management server 6.

In response to receiving the image file of the capture image from the personal terminal 2c, the content management server 6 associates the image file with information such as a user ID, a room ID, and a sheet ID by the storing/reading unit 65, and transmits the image file associated with the information as the capture image information to the personal terminal 2c.

Sequence of Operation of Displaying Information on Interested Part:

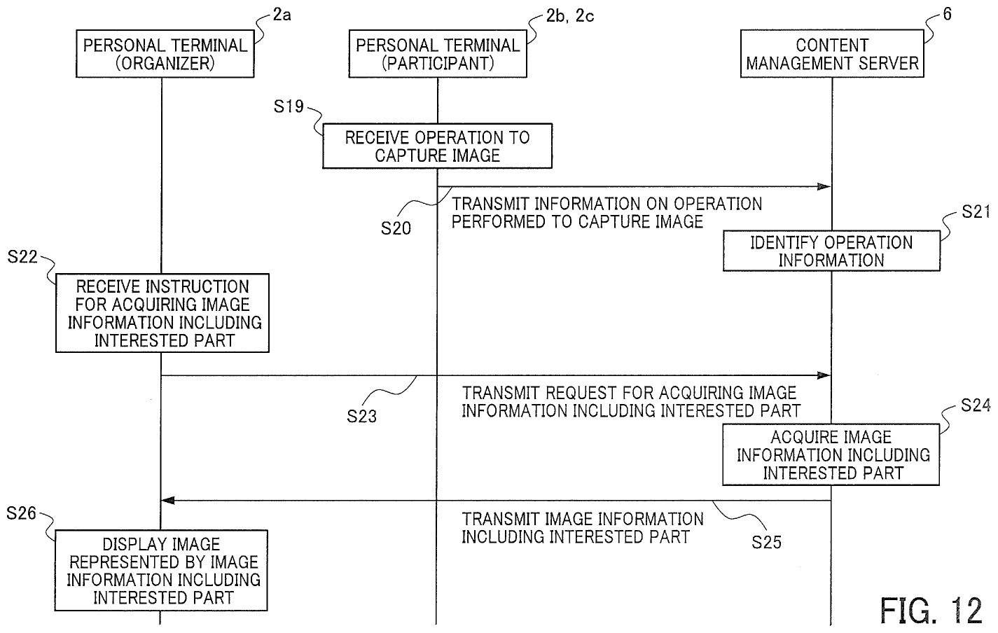

FIG. 12 is a sequence diagram illustrating an example of operation of displaying information on an interested part on the personal terminal 2a of the organizer.

The operation of this sequence diagram is performed when the participant performs an operation such as drawing or adding a sticker on a part in which the participant is interested in the capture image captured to the personal terminal 2 of the participant by processes of step S1 to step S18 described above. Further, the operation is performed when the organizer of the event wants to grasp the operation performed by the participant of the event on the capture image.

The personal board dc2 is displayed on the display device 505 of the personal terminal 2b, and the personal board dc3 is displayed on the display device 505 of the personal terminal 2c. Further, in the capture image display area 702 of each of the personal boards dc2 and dc3, the capture image captured from the shared image displayed in the shared screen display area 700 is displayed. In this state, the participant can perform various operations on the capture image displayed in the capture image display area 702 of the personal board dc.

Examples of the various operations include: (1) an operation of registering the capture image displayed in the capture image display area 702 as a favorite page; (2) an operation of adding a fixed object such as a sticker on the capture image displayed in the capture image display area 702; (3) an operation of drawing an object on the capture image displayed in the capture image display area 702 using the pen tool, for example; (4) an operation of viewing the capture image displayed in the capture image display area 702; and (5) an operation of acquiring information on the participant's motion with respect to the capture image displayed in the capture image display area 702 using a recording device. A detailed description is given below of the above operations.

When the participant performs an operation such as drawing an object or adding a sticker on the capture image displayed in the capture image display area 702, each of the reception unit 22b of the personal terminal 2a and the reception unit 22c of the personal terminal 2c receives the operation performed on the capture image (step S19).

When each of the reception unit 22b of the personal terminal 2b and the reception unit 22c of the personal terminal 2c receives the operation performed on the capture image, each of the data exchange unit 21b of the personal terminal 2b and the data exchange unit 21c of the personal terminal 2c transmits information on the operation performed on the capture image to the content management server 6 (step S20).

The information on the operation performed on the capture image includes information such as a personal memo ID, a sheet ID, and content data. Thus, the data exchange unit 61 of the content management server 6 receives the information on the operation performed on the capture image transmitted from the personal terminal 2b and the personal terminal 2c.

In response to the reception of operation information indicating the operation performed on the capture image at each of the personal terminal 2b and the personal terminal 2c, the identification unit 63 of the content management server 6 identifies a part where the operation is performed on the capture image based on the received operation information (step S21). In this example, the part where the operation is performed indicates an interested part (e.g., a part in which the participant is interested). Examples of the operation information includes the following (1) to (5).

(1) Page number information (sheet ID) of a capture image to be registered as a favorite page. The page number information is transmitted from the personal terminal in response to pressing of the favorite setting button 712 to register the capture image as a favorite page.

(2) Coordinate information of a sticker. The coordinate information is transmitted from the personal terminal in response to an operation to the sticker tool to add a sticker on the capture image (or to add a fixed object).

(3) Pen color information and drawing coordinate information. The pen color information and the drawing coordinate information are transmitted from the personal terminal 2 in response to an operation of drawing an object using the pen tool to draw an object on the capture image.

(4) Page number information (sheet ID) of a capture image that is viewed. The page number information is transmitted from the personal terminal 2 in response to an operation of viewing the capture image on the personal board dc.

(5) Coordinate information of a line of sight. The coordinate information of line of sight is transmitted from the personal terminal 2 in response to an operation of tracking a movement of the participant's line of sight with respect to the capture image using an external recording device, for example.

Based on the operation information of (1) to (5) described above, the identification unit 63 of the content management server 6 identifies a part in which the participant is interested in the capture image as follows.

Regarding the above operation information (1), the identification unit 63 identifies, based on the received sheet ID, an entire page corresponding to the sheet ID as the part in which the participant is interested. The sheet ID is stored in the personal memo management information table in the storage unit 66.

Regarding to the above operation information (2), the identification unit 63 identifies, based on the received coordinate information, a position at which the sticker is added as a part in which the participant is interested. The coordinate information of the sticker is stored in the personal memo information table in the storage unit 66.

Regarding the above operation information (3), the identification unit 63 identifies, based on the received color information and coordinate information, a position at which the object is drawn as a part in which the participant is interested. Further, the identification unit 63 identifies an object drawn in a color other than black as a part in which the participant is interested. Further, the identification unit 63 identifies an object drawn as a figure as a part in which the participant is interested. The color information and the coordinate information are stored in the personal memo information table in the storage unit 66.

Regarding the above operation information (4), the identification unit 63 identifies, based on the received sheet ID, an entire page that is viewed corresponding to the sheet ID as a part in which the participant is interested. The sheet ID is stored in the personal memo management information table in the storage unit 66.

With respect to the above operation information (5), the identification unit 63 identifies, based on the received coordinate information of line of sight, a position at which the participant was staring at in the capture image as a part in which the participant is interested. The coordinate information of line of sight is stored in the personal memo information table in the storage unit 66.

The storing/reading unit 65 of the content management server 6 stores, in the storage unit 66, information of the part in which the participant is interested that is identified by the identification unit 63 based on the operation information (1) to (5). In the following description, the part in which the participant is interested may be referred to as an “interested part”. On the other hand, the organizer can collect information on the part in which the participant is interested in a document, during the event or after the end of the event. The above operation information (1) to (5) are merely examples of contents of the operation information. In another example, any other operation performed on the capture image are used as the operation information.

The display control unit 25a of the personal terminal 2a controls the display device 505 to display the personal portal dp1 in response to a predetermined input operation to the input device 506 by the organizer. Further, the organizer instructs to acquire image information including the participant's interested part on a screen of the personal portal dp1 displayed on the display device 505.

In response to the instruction to acquire the image information including the interested part from the organizer, the reception unit 22a of the personal terminal 2a receives the instruction to acquire the image information including the interested part (step S22).

In response to the reception of the instruction to acquire the image information including the interested part by the reception unit 22a of the personal terminal 2a, the data exchange unit 21a of the personal terminal 2a transmits a request to acquire the image information including the interested part to the content management server 6 (step S23).

The request to acquire the image information including the interested part includes event information such as a room ID identifying a location where the event is held. Thus, the data exchange unit 61 of the content management server 6 receives the request to acquire the image information including the interested part, the request being transmitted from the personal terminal 2a.

In response to the reception of the request to acquire the image information including the interested part, the storing/reading unit 65 of the content management server 6 reads information such as the personal memo management information table and the personal memo information table of the target event from the storage unit 66.

The collation unit 64 of the content management server 6 determines whether an image including the interested part is present based on the information read from the storage unit 66. Thus, the collation unit 64 of the content management server 6 acquires the image information including the interested part (step S24).

Next, the data exchange unit 61 of the content management server 6 transmits the image information including the interested part acquired in step S24 to the personal terminal 2a (step S25). Thus, the data exchange unit 21a of the personal terminal 2a receives the image information including the interested part transmitted from the content management server 6.

Next, the display control unit 25a of the personal terminal 2a controls the display device 505 to display the image information including the interested part based on the information received in step S25 (step S26). Although the description given above is of an example in which the process of step S24 (i.e., the acquisition of the image information including the interested part) is performed in response to the request from the organizer, in another example, the process of step S24 is performed subsequent to step S21.

Examples of Display Screens:

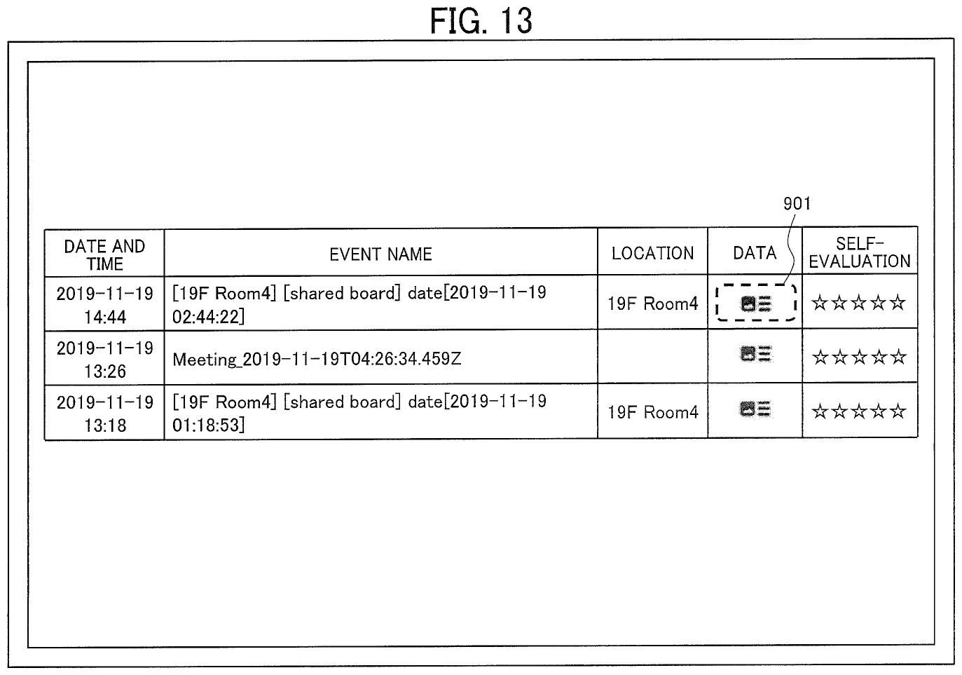

FIG. 13 to FIG. 17 are illustrations of display examples of screens displayed mainly on the personal terminal 2a of the organizer.

FIG. 13 is an illustration of an example of an event list display screen displaying a list of events.

The event list display screen is a screen that is first displayed on the display device 505 of the personal terminal 2a by the process of step S26 in FIG. 12 (i.e., the process of displaying the image information including the interested part). The display control unit 25a of the personal terminal 2a controls the display device 505 to display the event list display screen based on the image information including the interested part transmitted from the content management server 6.

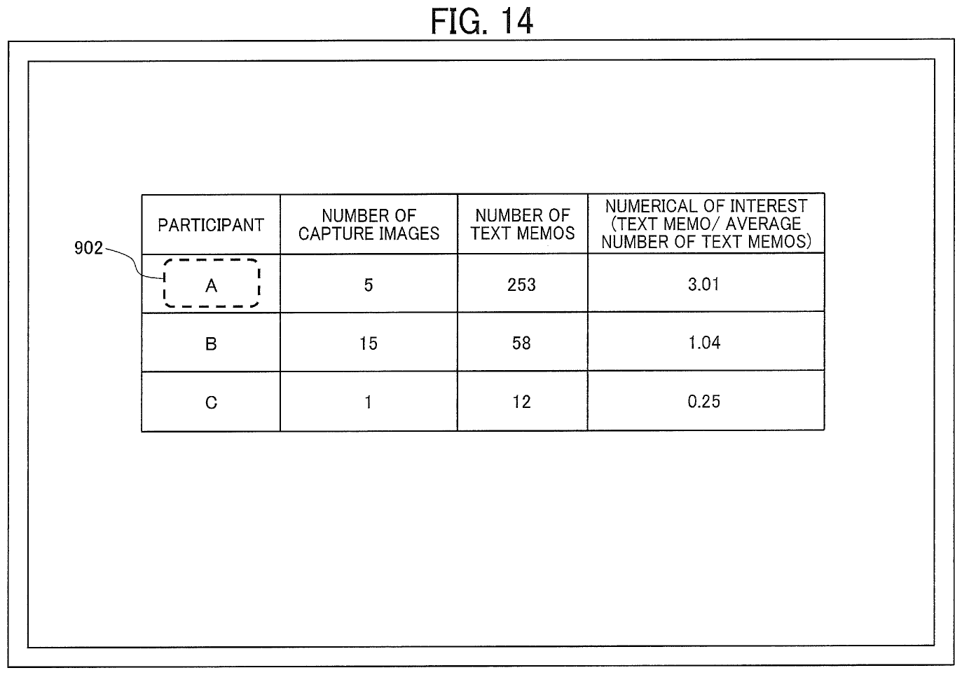

The list includes a date and time of an event, an event name, a location of the event, information of a document or the like used in the event. A display screen displayed on the display device 505 transitions to a screen as illustrated in FIG. 14 in response to, for example, the organizer's operation of selecting an icon indicated by a broken line 901 in the list.

FIG. 14 is an illustration of an example of an event data display screen.

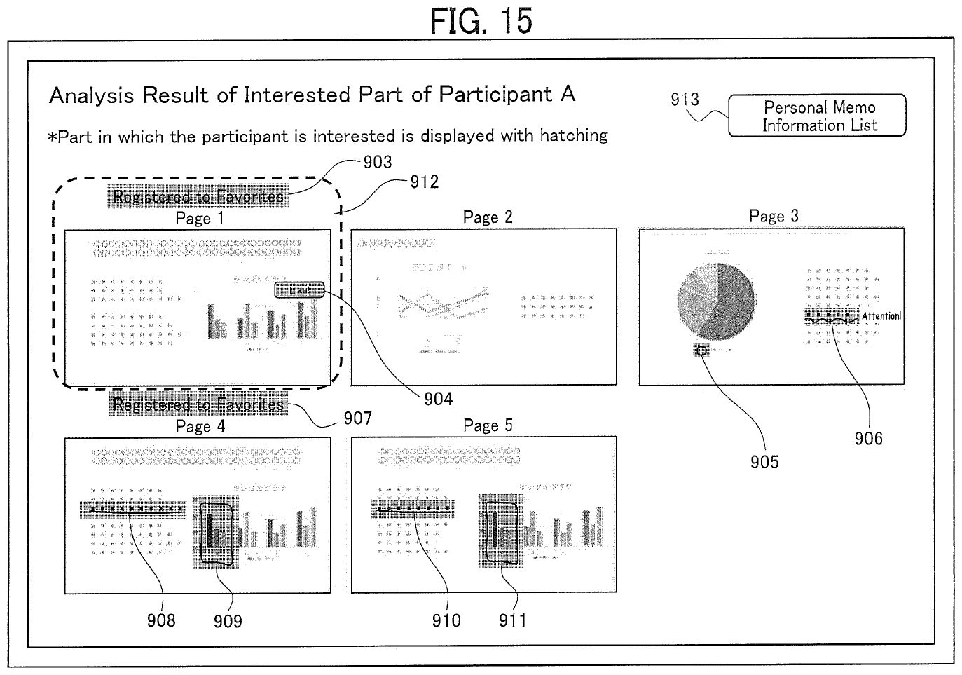

The event data display screen includes information such as a participant(s) participating in a target event, the number of capture images captured by the participant to the personal terminal 2, and the number of text memos written in the capture image. A display screen displayed on the display device 505 transitions to a screen as illustrated in FIG. 15 in response to the organizer's operation to an area indicated by a broken line 902.

FIG. 15 is an illustration of an example of an interested part analysis result display screen.

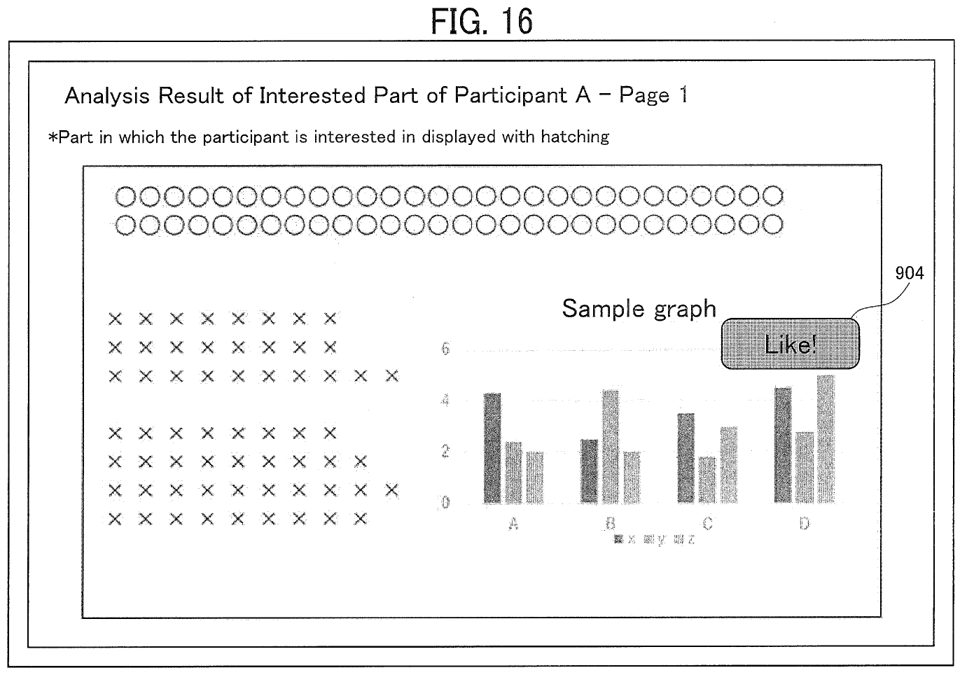

The interested part analysis result screen displays an analysis result of parts in which a particular participant is interested in. For example, the organizer recognizes that a participant A has captured five documents from the screen of FIG. 15. Further, parts where the participant A performs an operation on the capture images are indicated by text 903 to a box 911 that are hatched. A display screen displayed on the display device 505 transitions to a screen as illustrated in FIG. 16 in response to the organizer's operation to area indicated by a broken line 912. The user can view the interested part on a page-by-page basis. In response to pressing a personal memo information list button 913, a personal memo information list is displayed. A detailed description is given below of the personal memo information list.

FIG. 16 is an illustration of another example of the interested part analysis result display screen.

The interested part analysis result screen of FIG. 16 displays an analysis result of parts in which a particular participant (in this example, User A) is interested one page at a time.

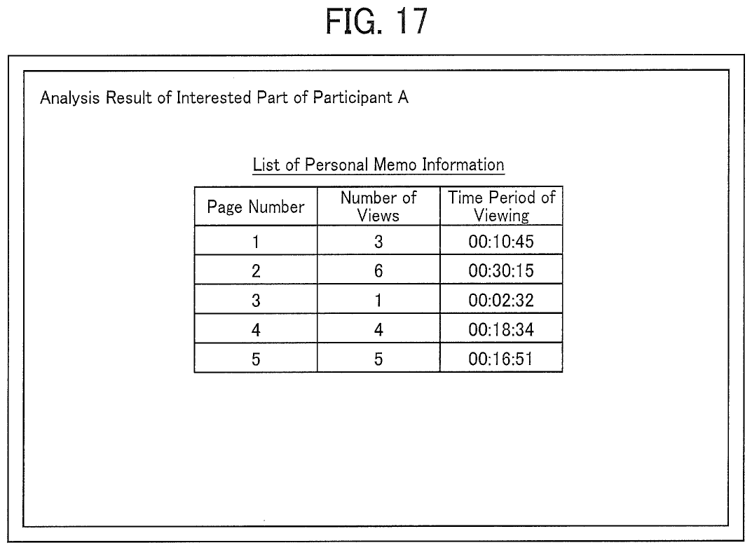

FIG. 17 is an illustration of an example of a page information list of a personal memo.

The page information list of the personal memo displays a list of information such as pages of a document captured by a particular participant, the number of times each page is viewed by the particular participant, and a time period during which each page is viewed by the particular participant. The page information list of the personal memo in response to pressing a personal memo information list button 913 illustrated in FIG. 15.

Operations Performed on Capture Image:

A description is now given of operations performed on a capture image captured to the capture image display area 702 at the personal terminal 2.

Register to Favorites:

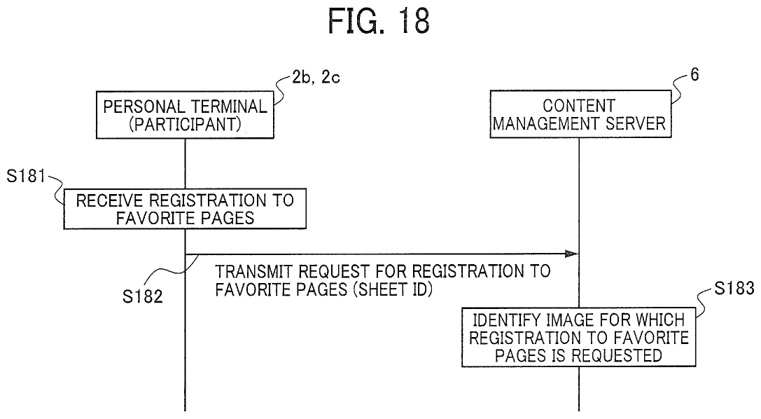

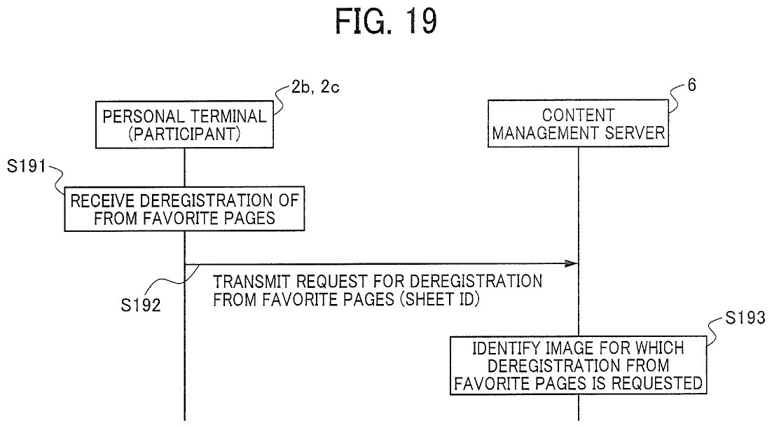

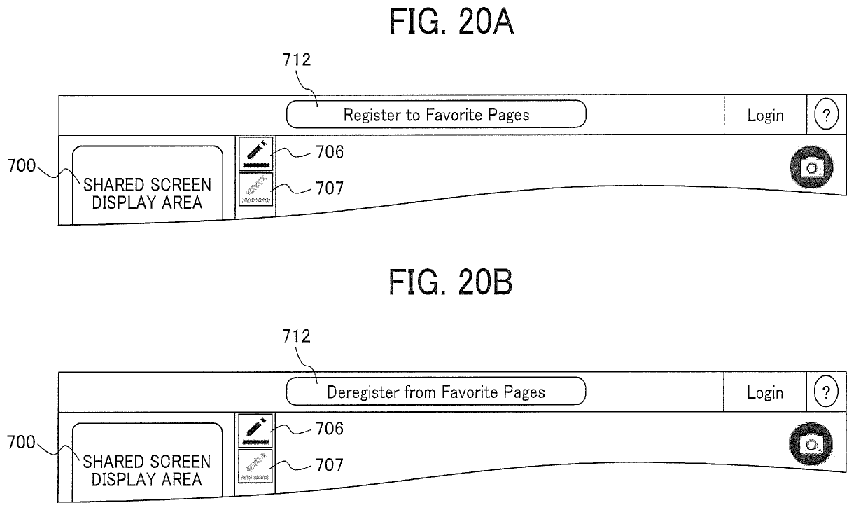

A description is now given of an operation of performing “registration to favorites” on the capture image displayed in the capture image display area 702 with reference to FIG. 18, FIG. 19, FIG. 20A, and FIG. 20B.

FIG. 18 is a sequence diagram illustrating an example of operation of registering a capture image as a favorite page.

The screen of the personal board dc is in a state illustrated in FIG. 7. To register a capture image displayed in the capture image display area 702 of the personal board dc as a favorite page, the participant presses the favorite setting button 712 displayed on the upper part of the capture image display area 702.

In response to the participant's pressing of the favorite setting button 712, the reception unit 22 of the personal terminal 2 receives an instruction to register the capture image as a favorite page (step S181).

In response to the reception the instruction to register the capture image as a favorite page by the reception unit 22 of the personal terminal 2, the data exchange unit 21 of the personal terminal 2 transmits, to the content management server 6, a request to register the capture image as a favorite page (step S182). In the following description, the request to register the capture image as a favorite page may be referred to as a “favorite registration request”.

The favorite registration request includes information such as a sheet ID identifying the capture image to be registered as a favorite page. Thus, the data exchange unit 61 of the content management server 6 receives the favorite registration request transmitted from the personal terminal 2.

In response to the reception of the favorite registration request, the identification unit 63 of the content management server 6 identifies, based on the received sheet ID, an entire page corresponding to the sheet ID as a part in which the participant is interested (step S183).

The storing/reading unit 65 of the content management server 6 stores the information on the interested part identified by the identification unit 63 in the storage unit 66. As a result, data in the “registration to favorites” in the personal memo management information table illustrated in FIG. 8 is updated from “not registered” to “registered”. When the page for which the favorite registration operation has been performed on the capture image is displayed as the interested part analysis result in response to, for example, the organizer's operation, the page is marked with text 903 or text 907 that are hatched, such as “Registered to Favorites”, as illustrated in FIG. 15.

FIG. 19 is a sequence diagram illustrating an example of operation of deregistering a capture image from favorite pages.

To deregister the page that has been registered as a favorite page from favorite pages, the participant presses the favorite setting button 712 displayed on the upper part of the capture image display area 702.

Text displayed in the favorite setting button 712 switches in response to the registration to favorite pages and deregistration from favorite pages. FIG. 20A and FIG. 20B illustrates such switching of the favorite setting button 712. When the target capture image is not registered as a favorite page, text “Register to Favorite Pages” is displayed in the favorite setting button 712 as illustrated in FIG. 20A.

In contrast, once the target capture image is registered as a favorite page, text displayed in the favorite setting button 712 is switched to “Deregister from Favorite Pages” as illustrated in FIG. 20B. Thus, the participant can easily recognize the state of registration as a favorite page by checking the text displayed in the favorite setting button 712. This reduces of eliminates an erroneous operation.

Referring again to FIG. 19, in response to pressing of the favorite setting button 712 by the participant, the reception unit 22 of the personal terminal 2 receives an instruction for deregistering the capture image from favorite pages (step S191).

In response to the reception of the instruction for deregistering the capture image from favorite pages by the reception unit 22 of the personal terminal 2, the data exchange unit 21 of the personal terminal 2 transmits a request to deregister the capture image from favorite pages to the content management server 6 (step S192).

The request to deregister the capture image from favorite pages includes information such as a sheet ID identifying a target page that is to be deregistered from favorite pages. Thus, the data exchange unit 61 of the content management server 6 receives the request to deregister the capture image from favorite pages, the request being transmitted from the personal terminal 2.

In response to the reception of the request to deregister the capture image from favorite pages, the identification unit 63 of the content management server 6 identifies, based on the received sheet ID, information on an image that is to be deregistered from favorite pages (step S193). The storing/reading unit 65 of the content management server 6 stores the information on the image identified by the identification unit 63 in the storage unit 66. As a result, data in the “registration to favorites” in the personal memo management information table illustrated in FIG. 8 is updated from “registered” to “not registered”.

Further, the text displayed in the favorite setting button 712 switched back to “Register to Favorite Pages” from “Deregister from Favorite Pages”. Furthermore, when the page for which the favorite deregistration operation has been performed on the capture image is displayed as the interested part analysis result in response to, for example, the organizer's operation, the text 903 or the text 907 that are hatched is deleted from the page.

Adding Fixed Object:

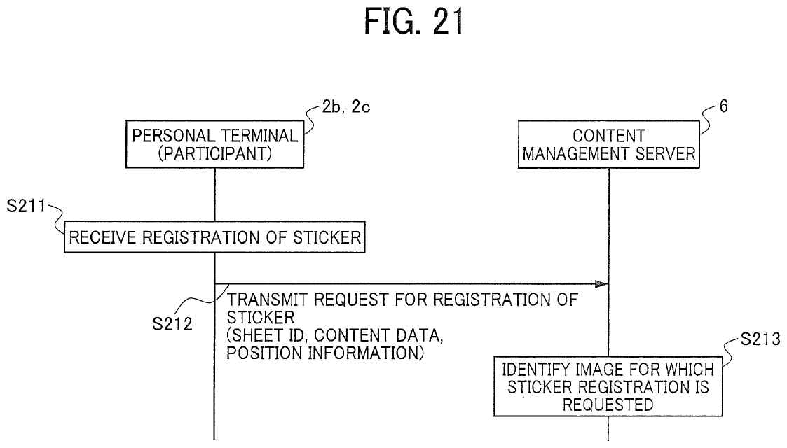

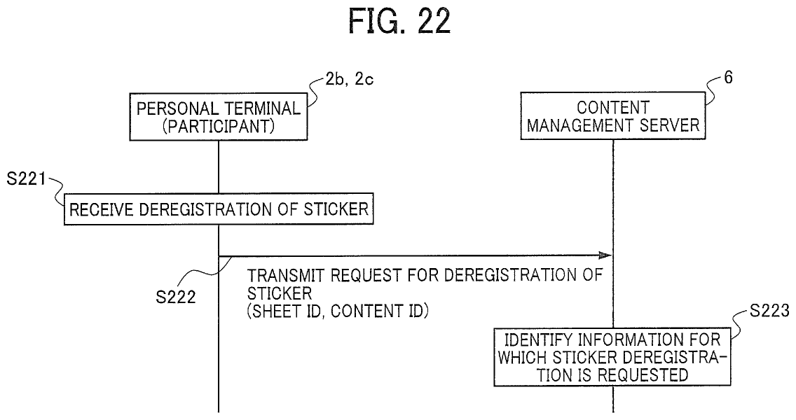

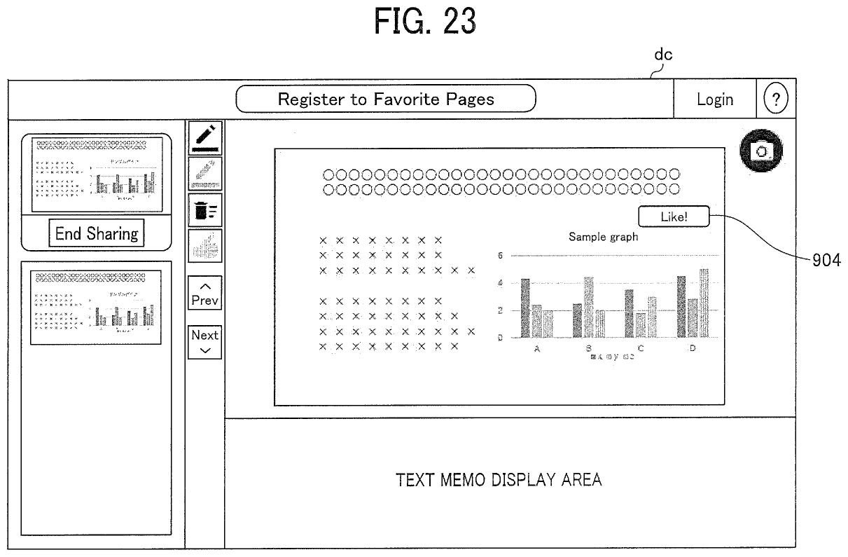

A description is now given of an operation of adding a fixed object on the capture image displayed in the capture image display area 702 with reference to FIG. 21, FIG. 22, and FIG. 23. In this description, the term “fixed object” refers to a character string or a figure having a predetermined shape. A typical example of the fixed object includes a sticker. In the following description, an operation of adding an object to a capture image using a sticker tool is described.

FIG. 21 is a sequence diagram illustrating an example of operation of adding a fixed object.

To add a sticker as an example of the fixed object to a capture image displayed in the capture image display area 702 of the personal board dc, the participant selects the sticker button 709 from buttons displayed on the left of the capture image display area 702. Next, the participant places the sticker at a desired position on the capture image where the sticker is to be added and performs an operation of adding the sticker. In response to the participant's operation of adding the sticker, the reception unit 22 of the personal terminal 2 receives registration of the sticker (step S211).

In response to the reception of the registration of the sticker by the reception unit 22 of the personal terminal 2, the data exchange unit 21 of the personal terminal 2 transmits a request to register the sticker to the content management server 6 (step S212).

The request to register the sticker includes, for example, a sheet ID identifying the target page and sticker coordinate information. Thus, the data exchange unit 61 of the content management server 6 receives the request to register the sticker, the request being transmitted from the personal terminal 2.

In response the reception of the request to register the sticker, the identification unit 63 of the content management server 6 identifies, based on the received coordinate information, the position at which the stamp is pressed as the part in which the participant is interested (step S213). The storing/reading unit 65 of the content management server 6 stores the information on the interested part identified by the identification unit 63 in the storage unit 66. Further, the storage unit 66 updates information in the personal memo information table illustrated in FIG. 9.

The capture image on which the sticker is added as described above is displayed on the personal board dc of the participant's personal terminal 2 as a screen as illustrated in FIG. 23. Further, when the page for which the operation of adding the sticker has been performed on the capture image is displayed as the interested part analysis result in response to, for example, the organizer's operation, a sticker “Like!” 904 is displayed with hatching as illustrated in FIG. 15 and FIG. 16.

FIG. 22 is a sequence diagram illustrating an example of operation of erasing a fixed object.

To erase the sticker added to the capture image, the participant selects the eraser button 708 from buttons displayed on the left of the capture image display area 702. Further, the participant moves the eraser tool over a desired sticker portion on the capture image to delete the sticker.

In response to the participant's operation of deleting the sticker, the reception unit 22 of the personal terminal 2 receives deregistration of the sticker (step S221).

In response to the reception of the deregistration of the sticker by the reception unit 22 of the personal terminal 2, the data exchange unit 21 of the personal terminal 2 transmits a request to deregister the sticker to the content management server 6 (step S222).

The request to deregister the sticker includes information such as a sheet ID and a content ID. Thus, the data exchange unit 61 of the content management server 6 receives the request to deregister the sticker, the request being transmitted from the personal terminal 2.

In response to the reception of the request to deregister the sticker, the identification unit 63 of the content management server 6 identifies, based on the received sheet ID and the content ID, information on an image for which the sticker is to be deregistered (step S223). The storing/reading unit 65 of the content management server 6 stores the information on the image identified by the identification unit 63 in the storage unit 66. Further, the storage unit 66 updates information in the personal memo information table illustrated in FIG. 9.

Furthermore, when the page for which the sticker deregistration operation has been performed on the capture image is displayed as the interested part analysis result in response to, for example, the organizer's operation, the hatched sticker such as the “Like!” 904 is deleted from the page.

Drawing of Object:

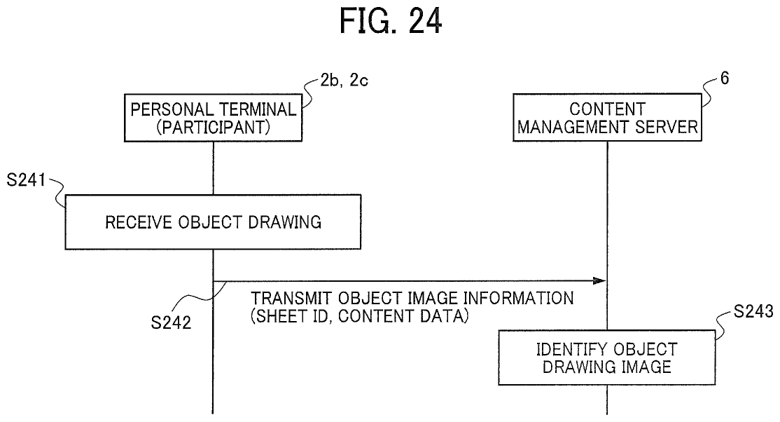

A description is now given of an operation of drawing an object on the capture image displayed in the capture image display area 702 with reference to FIG. 24 to FIG. 28. In this description, “drawing of an object” refers to a character or a figure freely written by a user (participant) unlike the fixed object described above. A typical example of the drawing an object is drawing with the pen tool.

In the following description, an operation of drawing an object using the pen tool on a capture image is described.

FIG. 24 is a sequence diagram illustrating an example of operation of drawing an object.

To draw an object on a capture image displayed in the capture image display area 702 of the personal board dc, the participant selects a pen button (e.g., the black pen button 706 or the red pen button 707) from buttons displayed on the left of the capture image display area 702.

Next, the participant places a virtual pen at a desired position on the capture image where an object is to be drawn and performs an operation of drawing an object such as a character or a figure. In response to the participant's operation of drawing the object, the reception unit 22 of the personal terminal 2 receives an object drawing (step S241).

In response to the reception of the object drawing by the reception unit 22 of the personal terminal 2, the data exchange unit 21 of the personal terminal 2 transmits object drawing information to the content management server 6 (step S242).

The object drawing information includes, for example, a sheet ID, color information, and coordinate information. Thus, the data exchange unit 61 of the content management server 6 receives the object drawing information transmitted from the personal terminal 2.

In response the reception of the object drawing information, the identification unit 63 of the content management server 6 identifies, based on the received coordinate information, the position at which the object is drawn as the part in which the participant is interested (step S243). The storing/reading unit 65 of the content management server 6 stores the information on the interested part identified by the identification unit 63 in the storage unit 66. Further, the storing/reading unit 65 updates information in the personal memo information table illustrated in FIG. 9 stored in the storage unit 66.

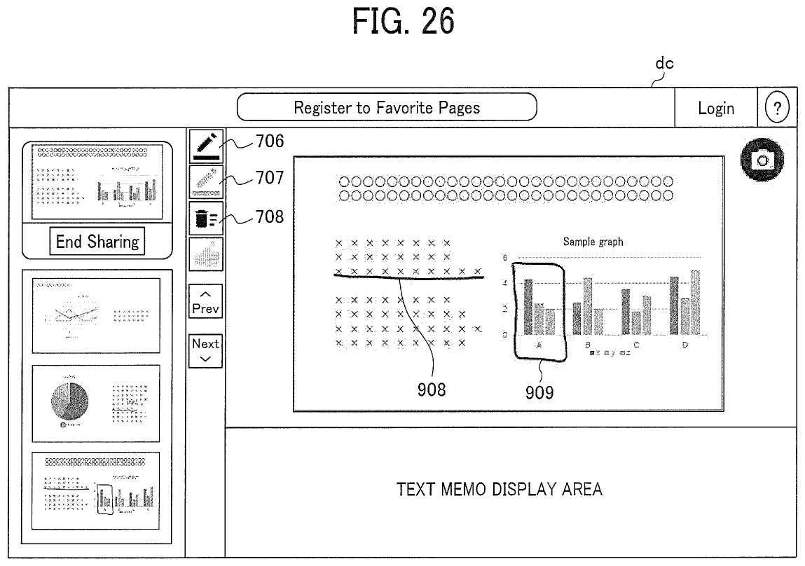

The capture image on which the object is drawn as described above is displayed on the personal board dc of the participant's personal terminal 2 as a screen as illustrated in FIG. 26. In FIG. 26, an underline 908 and a box 909 surrounding a graph are objects drawn by the participant.

Further, when the page for which the operation of drawing an object has been performed on the capture image is displayed as the interested part analysis result in response to, for example, the organizer's operation, a circle 905, an underline 906, the underline 908, the box 909, an underline 910, and the box 911 are displayed with hatching as illustrated in FIG. 15.

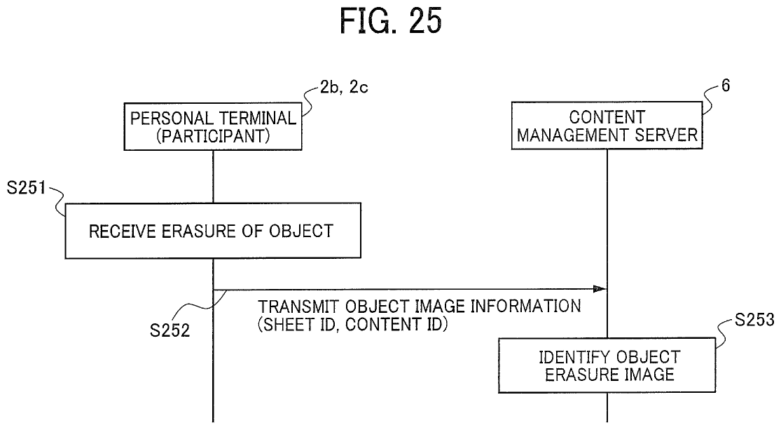

FIG. 25 is a sequence diagram illustrating an example of operation of erasing an object.

The operation of erasing the object drawn on the capture image is performed using the eraser button 708 in the same of substantially the same manner as erasing the fixed object described with reference to FIG. 22.

The participant selects the eraser button 708. Further, the participant moves the eraser tool over a desired object portion on the capture image to delete the object. In response to the participant's operation of erasing the object, the reception unit 22 of the personal terminal 2 receives the erasure of the object (step S251).

In response to the reception of the erasure of the object by the reception unit 22 of the personal terminal 2, the data exchange unit 21 of the personal terminal 2 transmits object image information to the content management server 6 (step S252). The object image information includes information such as a sheet ID and a content ID. Thus, the data exchange unit 61 of the content management server 6 receives the object image information transmitted from the personal terminal 2.

In response to the reception of the object image information, the identification unit 63 of the content management server 6 identifies, based on, for example, the received sheet ID and content ID, an object erasure image (step S253). The storing/reading unit 65 of the content management server 6 stores the image information identified by the identification unit 63 in the storage unit 66. Further, the storage unit 66 updates information in the personal memo information table illustrated in FIG. 9. Furthermore, when the page for which an operation of erasing an object has been performed on the capture image is displayed as the interested part analysis result in response to, for example, the organizer's operation, the hatched object is deleted from the page.

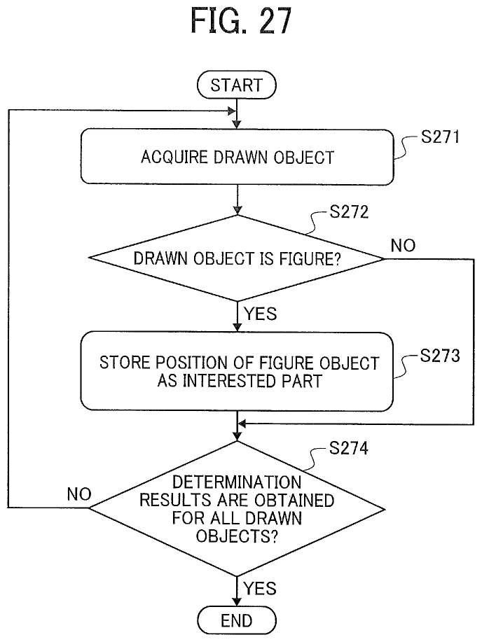

FIG. 27 is a flowchart illustrating operation of determining interest for a drawn object.

The acquisition of the image information including the interested part is basically performed by the process of step S24 described above with reference to the sequence diagram of FIG. 12. However, for drawn objects, a drawn object does not necessarily indicate a part in which the participant is interested. To address such issue, in one example, for drawn objects, the image information including the interested part is acquired by the operation illustrated in flowchart of FIG. 27.

In the operation of determining interest illustrated in FIG. 27, the storing/reading unit 65 of the content management server 6 acquires information on drawn object drawn by the participant (step S271). Next, the collation unit 64 determines, for each drawn object, whether the drawn object is a figure or a character(s) (step S272).

Based on the determination result indicating that the drawn object is a figure (S272: YES), the collation unit 64 stores the position (coordinates) at which the figure object is drawn in the storage unit 66 of the content management server 6 (step S273).

The determination result in step S272 is also transmitted to the identification unit 63 of the content management server 6. Based on the determination result indicating that the drawn object is a figure, the identification unit 63 identifies the object drawn as a figure as a part in which the participant is interested.

The information on the figure is stored in the storage unit 66 as a part in which the participant is interested. The above-described processes of steps S271 to S273 are performed for each drawn object of each participant, and the determinations are completed on all the drawn object, the operation ends (step S274).

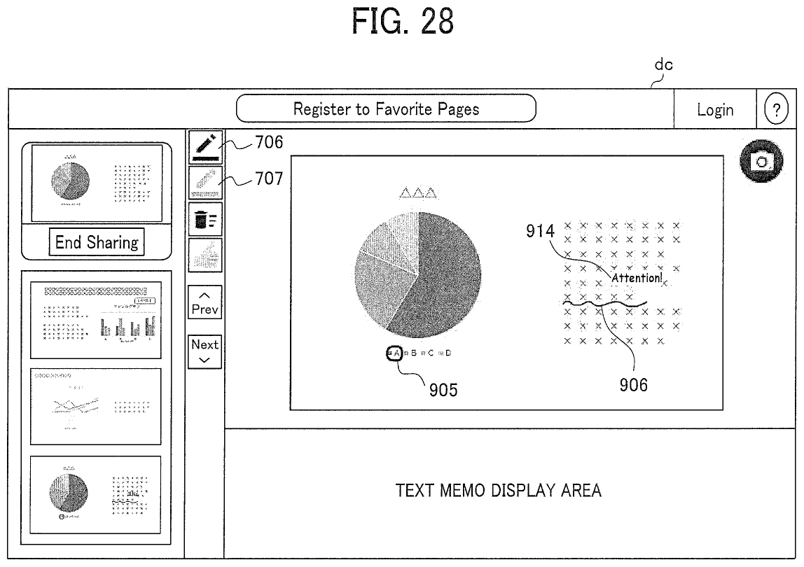

FIG. 28 is an illustration of another example of a display screen when an object is drawn.

In this disclosure, the black pen button 706 and the red pen button 707 are provided on the personal board dc. In this case, as illustrated in FIG. 28, some participants draw objects in different colors for different purposes, e.g., use a black pen for the circle 905 and the underline 906 and uses a red pen for an interested part 914. In view of such issue, in one example, for drawn objects, the image information including the interested part is acquired by designating the color of the pen tool used for drawing an object.

In this case, the identification unit 63 of the content management server 6 identifies, based on the received color information and coordinate information, an object drawn in a color other than black as a part in which the participant is interested. Further, the storing/reading unit 65 of the content management server 6 stores the information on the interested part identified by the identification unit 63 in the storage unit 66. Furthermore, the storing/reading unit 65 updates information in the personal memo information table illustrated in FIG. 9 stored in the storage unit 66.

Viewing Information:

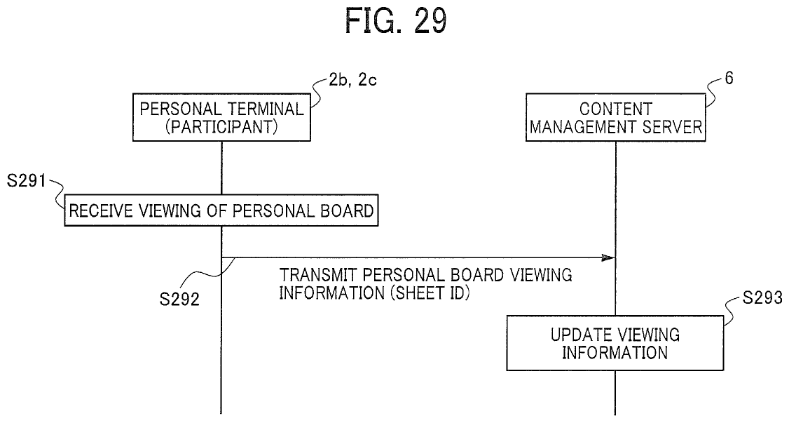

A description is now given of an operation of viewing a capture image with reference to FIG. 29.

FIG. 29 is a sequence diagram illustrating operation performed when a capture image is viewed.

The participant can access the personal portal dp to view the personal board dc after the event ends. In the operation of this sequence diagram, when the participant reviews the personal board dc after the end of event, a time period of viewing and the number of times of viewing are recorded.

First, the participant operates the personal terminal 2 access the personal portal dp and accesses the personal board dc from the personal portal dp. When the participant accesses the personal board dc and performs an operation of viewing a capture image, the reception unit 22 of the personal terminal 2 receives viewing of the personal board (step S291).

In response to receiving the viewing of the personal board by the reception unit 22 of the personal terminal 2, the data exchange unit 21 of the personal terminal 2 transmits personal board viewing information to the content management server 6 (step S292). The personal board viewing information includes information such as a sheet ID. Thus, the data exchange unit 61 of the content management server 6 receives the personal board viewing information transmitted from the personal terminal 2.

In response to the reception of the personal board viewing information, the identification unit 63 of the content management server 6 identifies, based on the received sheet ID, an entire page corresponding to the sheet ID as a part in which the participant is interested (step S293). The storing/reading unit 65 of the content management server 6 stores the information on the interested part identified by the identification unit 63 in the storage unit 66. Further, the storing/reading unit 65 updates information of the number of views and the time period of viewing in the personal memo management information table (see FIG. 8) stored in the storage unit 66.

For example, in response to the reception of the personal board viewing information from the personal terminal 2, the storing/reading unit 65 of the content management server 6 starts incrementing the number of views and starts measuring the time period of viewing for a page (sheet) corresponding to the sheet ID included in the personal board viewing information. The storing/reading unit 65 finishes measuring the time period of viewing in response to the participant's operation of closing of the personal board dc.

When the number of pages as a viewing target is two or more, the measurement of the time period of viewing of the first page ends in response to a transition of the participant's viewing target from the first page to the second page and the start of the measurement of the time period of viewing of the second page.

Participant's Motion Information:

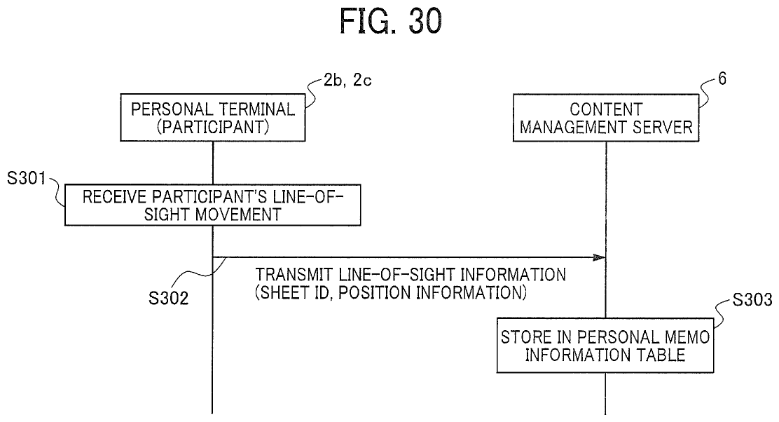

A description is now given of operation of analyzing an interested part based on information of a participant's line of sight with respect to a capture image during an event using an external recording device, with reference to FIG. 30.

FIG. 30 is a sequence diagram illustrating operation of analyzing an interested part based on information of a participant's line of sight.

In this disclosure, examples of the external recording device include a photographing device such as a camera connected to the external device I/F 508 of the personal terminal 2. In the following description, an example is described in which information of a line of sight of a participant who is participating in an event is acquired by a camera connected to the personal terminal 2, to identify an interested part.

The information of a movement of the line of sight of the participant with respect to the capture image displayed in the capture image display area 702 of the personal board dc is tracked by the camera. In response to data transmission from the camera, the reception unit 22 of the personal terminal 2 receives the data as the movement of the participant's line of sight (step S301).

In response to receiving the movement of the participant's line of sight by the reception unit 22 of the personal terminal 2, the data exchange unit 21 of the personal terminal 2 transmits line-of-sight information to the content management server 6 (step S302). The line-of-sight information includes, for example, a sheet ID identifying the target page and position information (coordinate information of the line of sight). Thus, the data exchange unit 61 of the content management server 6 receives the line-of-sight information transmitted from the personal terminal 2. In one example, the personal terminal 2 transmits all data of the line-of-sight information to the content management server 6. In another example, the personal terminal 2 transmits data satisfying a certain condition (e.g., staring at the same place for three seconds) to the content management server 6.

In response to the reception of the line-of-sight information, the identification unit 63 of the content management server 6 identifies, based on the received coordinate information of line of sight, a position at which the participant was staring at in the capture image as a part in which the participant is interested (step S303). The storing/reading unit 65 of the content management server 6 stores the information on the interested part identified by the identification unit 63 in the storage unit 66. Further, the storing/reading unit 65 stores the coordinate information of line of sight in the personal memo information table in the storage unit 66.

The operations performed by the participant on the capture image captured to the capture image display area 702 of the personal terminal 2 are described heretofore. A description is now given of operation performed when the conference organizer organizes capture images captured by the participants.

Sequence of Operation of Organizing Capture Images by Conference Organizer:

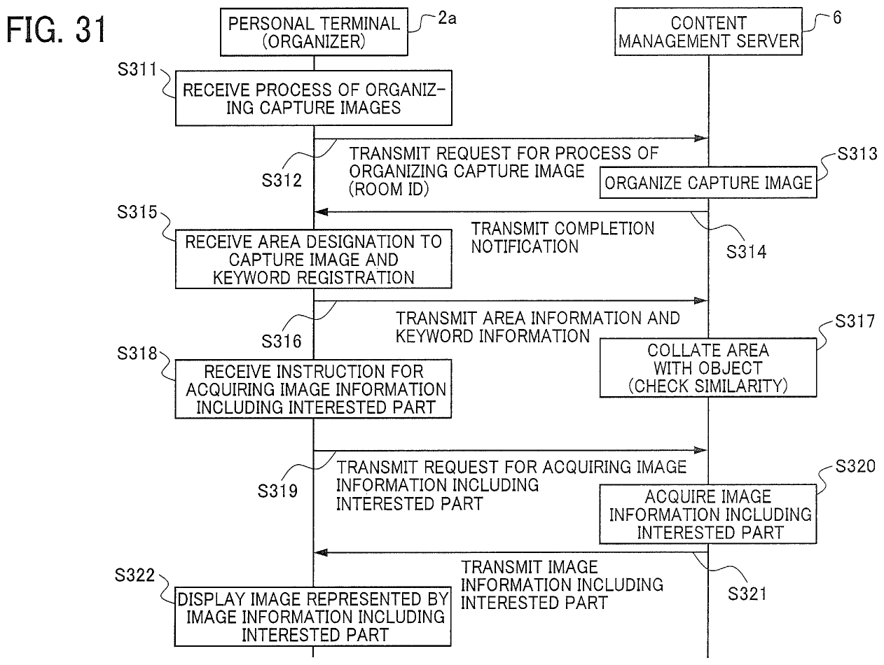

FIG. 31 is a sequence diagram illustrating of operation of designating an area and registering a keyword.

After an event ends, the organizer presses an event end button at the personal terminal 2a. When the organizer presses the event end button, the reception unit 22a of the personal terminal 2a receives processing for organizing capture images (step S311).

In response to the reception of the processing for organizing the capture images by the reception unit 22a of the personal terminal 2a, the data exchange unit 21a of the personal terminal 2a transmits a request to organize capture images to the content management server 6 (step S312).

The request to organize capture images includes information such as a room ID identifying an event. Thus, the data exchange unit 61 of the content management server 6 receives the request to organize capture images, the request being transmitted from the personal terminal 2a. Although the description given above is an example in which the request to organize capture images is transmitted in response to the organizer's operation of pressing the event end button, this is merely one example.

In another example, the end of the event is detected automatically at a time set in advance. In this case, the personal terminal 2a transmits the request to organize capture images to the content management server 6 in response to such automatic detection of the end of the event.

In response to receiving the request to organize capture images, the storing/reading unit 65 of the content management server 6 organizes capture images that the participants acquired, based on the information such as the room ID included the received request to organize capture images (step S313).

In organizing the capture images, the storing/reading unit 65 mainly checks whether there is a page or pages that is (are) captured for a plurality of times. Identifying the page(s) captured for a plurality of times in advance enables to analyze data accurately. The organization of the capture image is preferably performed while restricting the drawing (adding) of objects to the capture images, such as in a state in which the event has ended.

When the organization of the capture images is completed, the data exchange unit 61 of the content management server 6 transmits a completion notification to the personal terminal 2a (step S314). Next, the organizer creates an image for collation to be used to obtain image information including a part in which the participant is interested from capture images saved by the participant. In the following description, the image for collation may be referred to a “collation image”, to simplify the description.

The collation unit 64 of the content management server 6 collates the collation image with the capture image saved by the participant, to obtain the image information including a part in which the participant is interested. In order to create the collation image, the organizer first performs area designation with respect to a target image.

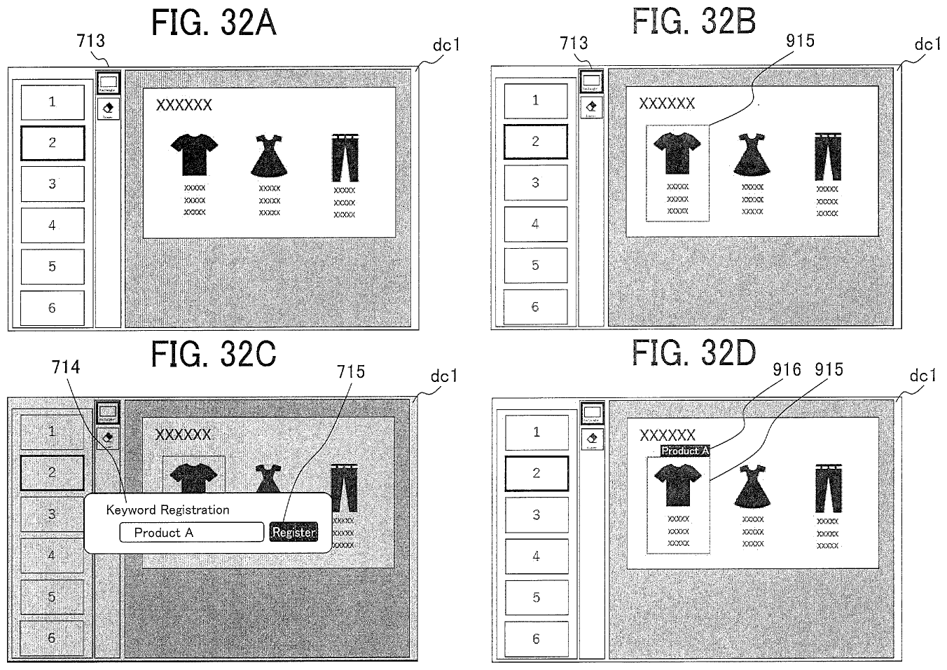

The personal terminal 2a of the organizer is configured to display a screen used for the area designation as illustrated in FIG. 32A on the personal board dc1. On the screen of FIG. 32A, the organizer presses an area designation button 713. Further, as illustrated in FIG. 32B, the organizer designates a portion for which the area is to be set. In this example, the area is designated by a rectangle 915.

In response to the area designation, a dialog box 714 for keyword registration is displayed as illustrated in FIG. 32C. The organizer enters desired text as a keyword in a field of the dialog box 714 for keyword registration displayed on the screen. After entering the keyword, the organizer presses a registration button 715. In response to the pressing of the registration button 715, the storing/reading unit 65 of the content management server 6 stores the keyword associated with the rectangle 915 in the storage unit 66.

After the registration, in order to clearly indicate that the keyword is registered, as illustrated in FIG. 32D, a keyword 916 is displayed along with the rectangle 915. In response to completion of the above-described operation, the reception unit 22a of the personal terminal 2a receives the area designation and the keyword registration for the capture image (step S315).

In response to receiving the area designation and the keyword registration for the capture image by the reception unit 22a of the personal terminal 2a, the data exchange unit 21a of the personal terminal 2a transmits area information and keyword information to the content management server 6 (step S316).

In response to the reception of the area information and the keyword information, the collation unit 64 of the content management server 6 collates position information of the area (rectangle 915) with the position information of an object drawn by the participant in the capture image, to determine a degree of matching such as whether there is a part in which the rectangle 915 and the drawn object overlap with each other (step S317).

The storing/reading unit 65 of the content management server 6 stores, in the storage unit 66, the collation result between the position information of the area (rectangle 915) and the position information of the drawn object on the capture image. Further, the organizer can give an instruction for displaying or searching the collation result as needed, to collect information on a part in which the participant is interested.

The display control unit 25a of the personal terminal 2a controls the display device 505 to display the personal portal dp1 in response to, for example, a predetermined input operation to the input device 506 by the organizer. Further, the organizer instructs to acquire image information including the participant's interested part on a screen of the personal portal dp1 displayed on the display device 505.

In response to the instruction to acquire the image information including the interested part from the organizer, the reception unit 22a of the personal terminal 2a receives the instruction to acquire the image information including the interested part (step S318). In response to the reception of the instruction to acquire the image information including the interested part by the reception unit 22a of the personal terminal 2a, the data exchange unit 21a of the personal terminal 2a transmits a request to acquire the image information including the interested part to the content management server 6 (step S319).

The request to acquire the image information including the interested part includes the event information such as a room ID identifying a location where the event is held. Thus, the data exchange unit 61 of the content management server 6 receives the request to acquire the image information including the interested part, the request being transmitted from the personal terminal 2a.

In response to the reception of the request to acquire the image information including the interested part, the storing/reading unit 65 of the content management server 6 reads information such as the personal memo management information table and the personal memo information table of the target event from the storage unit 66.

The collation unit 64 of the content management server 6 determines whether an image including the interested part is present based on the information read from the storage unit 66. Thus, the collation unit 64 of the content management server 6 acquires the image information including the interested part (step S320).

Next, the data exchange unit 61 of the content management server 6 transmits the image information including the interested part acquired in step S320 to the personal terminal 2a (step S321). Thus, the data exchange unit 21a of the personal terminal 2a receives the image information including the interested part transmitted from the content management server 6.

Next, the display control unit 25a of the personal terminal 2a controls the display device 505 to display the image information including the interested part based on the information received in step S321 (step S322). Although the description given above is of an example in which the process of step S320 (i.e., the acquisition of the image information including the interested part) is performed in response to the request from the organizer, in another example, the process of step S320 is performed subsequent to step S317. In still another example, if the result of the collation performed in step S317 suffices, the process of step S320 is omitted or not performed.

How to Collate Area with Drawn Object:

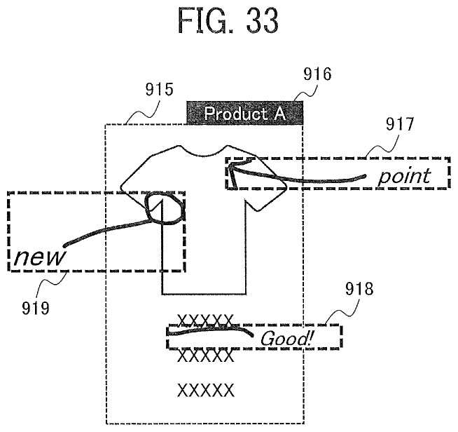

FIG. 33 is an illustration for describing how collation between the area and the drawn object is performed.

FIG. 33 schematically illustrates processing performed in step S317 (determination of the degree of matching) in the sequence diagram of FIG. 31. The rectangle 915 and the keyword 916 in FIG. 33 are set by the organizer.

On the other hand, a part including characters “point” and an arrow in a drawn object 917 drawn by the participant of the event. Further, a part including characters “Good!” and an underline is a drawn object 918 drawn by the participant of the event. Furthermore, a part including characters “new”, a circle, and a leading line is a drawn object 919 drawn by the participant of the event.

In step S317, the collation unit 64 of the content management server 6 collates the position information of the rectangle 915 with the position information of each of the drawn object 917, the drawn object 918, and the drawn object 919 to check whether any drawn object overlaps the area of the rectangle 915. In this example, regarding the drawn object 917, the arrow partially overlaps the area of the rectangle 915, while the characters “point” is outside the area of the rectangle 915. To address such case, the collation unit 64 of the content management server 6 checks a time when the drawing (writing) is performed in addition to the position information of the drawn object.

For example, when the collation unit 64 of the content management server 6 determines that two drawn objects are drawn at the same timing (e.g., within ten seconds), the collation unit 64 recognizes the two drawn objects as one drawn object and identifies an area including the two objects as an area of the one drawn object. Thus, the collation unit 64 of the content management server 6 associates the area (rectangle 915) and the keyword 916 set by the organizer with the drawn object 917, the drawn object 918, and the drawn object 919 drawn by the participant.

Determination of Degree of Interest:

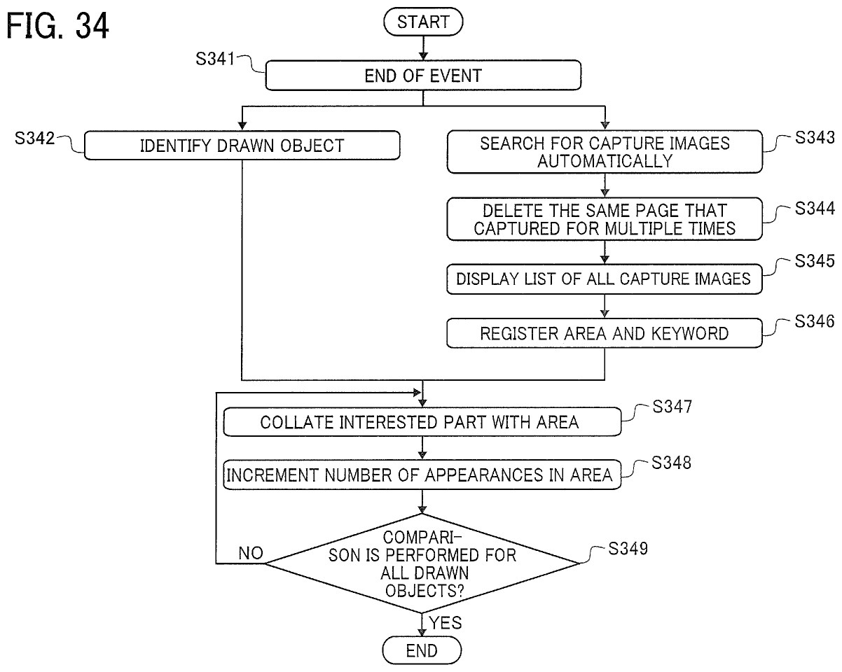

FIG. 34 is a flowchart illustrating an example of operation of determining a degree of interest.

This operation is triggered by, for example, the end of screen sharing or the timing when the event end button is pressed on the portal (step S341). The identification unit 63 of the content management server 6 identifies an object drawn by the participant at the timing of the end of the event. Specifically, the identification unit 63 identifies the drawn object based on the position information (coordinate information) included in the information of the personal memo information table illustrated in FIG. 9 (step S342).

Further, the storing/reading unit 65 of the content management server 6 searches capture images stored by the participant during the event using the user ID in the personal memo management information table as a search key (step S343). Further, the similarity determination unit 67 of the content management server 6 determines that the same page is captured a plurality of times based on the degree of similarity of images, to remove the same page. This process is performed to prevent an unnecessary page from being displayed because some participants may capture the same page a plurality of times (step S344).

After the removal of the same page is completed, the display control unit 25a of the personal terminal 2a displays a list of all capture images (step S345). Next, the organizer designates an area (corresponding to the rectangle 915 in the embodiment) and registers a keyword for the area. The storing/reading unit 65 of the content management server 6 stores the page information, the area information, and the keyword in the storage unit 66 in association with each other (step S346).

The collation unit 64 of the content management server 6 collates the coordinates of the drawn object identified in step S342 with the area registered in step S346 (step S347). When the drawn object and the area overlap with each other at least partially, the collation unit 64 identifies a part in which the drawn object and the area overlap as a part in which the participant is interested. In the following description, the part in which the participant is interested may be referred to as an “interested part”.

Each time a drawn object that overlaps the area appears, the collation unit 64 of the content management server 6 increments the number of appearances in the area (step S348). The collation unit 64 of the content management server 6 performs the collation process and the update of the number of appearances for all the drawn objects. When the collation process and the update of the number of appearances are performed for all the drawn objects, the operation ends (step S349).

Area/Keyword Information Management Table:

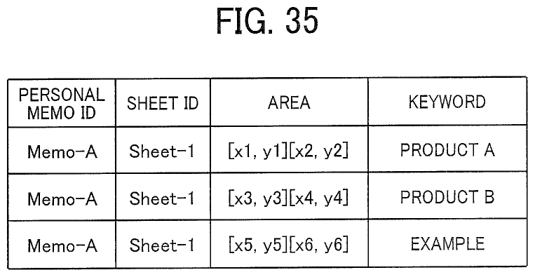

FIG. 35 is a diagram for describing an example of an area/keyword information management table.

The area/keyword information management table is stored in the storage unit 66 of the content management server 6 illustrated in FIG. 4. The area/keyword information management table stores a personal memo ID, a sheet ID, an area, and a keyword in association with one another. The personal memo ID is an example of personal memo identification information identifying a personal board dc. The sheet ID is an example of sheet identification information identifying a sheet.

The area is an example of area information identifying a position of an area such as the rectangle designated by the organizer. In this example, coordinate information is stored as the area. The keyword is text information registered by the organizer for the area.

FIG. 35 illustrates an example in which the organizer designates three areas for a document of one page identified by a sheet ID “Sheet-1”, and keywords “product A”, “product B”, and “example” are registered for the three areas respectively.

List of Participants' Interests:

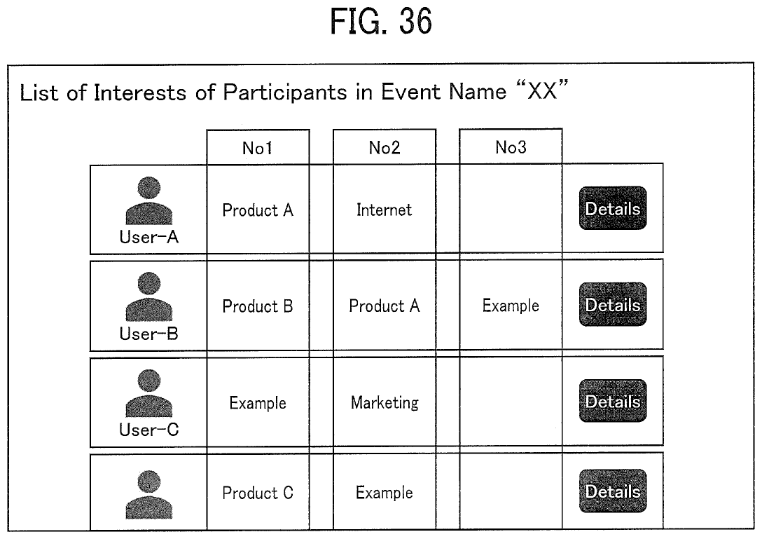

FIG. 36 is diagram for describing an example of a display screen of a list of participants' interests.

This display screen is displayed on the display device 505 of the personal terminal 2a of the organizer in step S322 of the sequence diagram of FIG. 31, for example. In response to the organizer's operation on the portal, for example, a list of interested parts of the participants on an event-by-event basis.

In the display screen example of FIG. 36, each participant' interests are displayed as being sorted by a keyword in a descending order. The sorting in this case is performed by using data obtained by the process of incrementing the number of appearances performed in step S348 of FIG. 34.

Automatic Registration of Keyword: Automatic Extraction from Drawn Object:

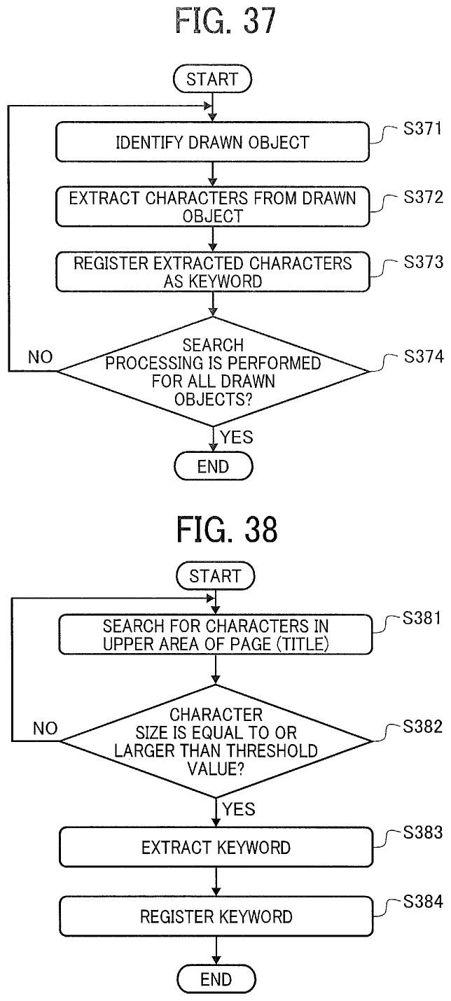

FIG. 37 is a flowchart illustrating an example of operation of registering a keyword automatically.

The above description given above is of an example in which a keyword is registered along with the designation of an area (the rectangle 915) by the organizer. The flowchart of FIG. 37 illustrates an example of operation of registering a keyword automatically based on a drawn object, instead of the registration of a keyword in response to the organizer's operation.

First, the identification unit 63 of the content management server 6 identifies a drawn object (step S371). Specifically, to identify the drawn object, the collation unit 64 of the content management server 6 collates the position information of the area with the position information of the drawn object, as described above with reference to FIG. 33.

Next, the collation unit 64 performs optical character recognition (OCR) is on a portion overlapping with the range of the drawn object (e.g., the upper left coordinates and the lower right coordinates of the drawn object) to extract characters (step S372). When the OCR recognition result indicates that the drawn object is a sentence, one or more words (nouns) are extracted by morphological analysis, for example.

The storing/reading unit 65 of the content management server 6 registers the word(s) extracted in step S372 as the keyword of the drawn object in the area/keyword information management table stored in the storage unit 66 of the content management server 6 (step S373). The collation unit 64 of the content management server 6 performs the search for word extraction on all the drawn objects. When the search for word extraction is performed for all the drawn objects, the operation ends (step S374).

Automatic Extraction from Title:

FIG. 38 is a flowchart illustrating another example of operation of registering a keyword automatically.

The flowchart of FIG. 38 illustrates an example of operation of registering a keyword automatically based on title information included in each page of a document used in the event, instead of the registration of a keyword in response to the organizer's operation.

First, the image processing unit 62 of the content management server 6 performs OCR searches for characters in an upper area of a sheet (e.g., substantially an upper one fourth area of the capture image) by OCR, for example (step S381). Next, the image processing unit 62 determines whether a size of the characters is equal to or larger than a threshold value (step S382). When the size of the characters is equal to or larger than a threshold value (step S382: YES), the image processing unit 62 identifies the characters whose size is equal to or larger than the threshold value as a title. Next, the collation unit 64 of the content management server 6 extracts a keyword from the characters identified as the title (step S383).

When the collation unit 64 determines that a drawn object is present in a page (sheet) from which the keyword is extracted, the storing/reading unit 65 of the content management server 6 registers keyword information on the extracted keyword to information of the participant who has drawn the object (step S384). The keyword information is registered in the area/keyword information management table stored in the storage unit 66 of the content management server 6.

Search Screen:

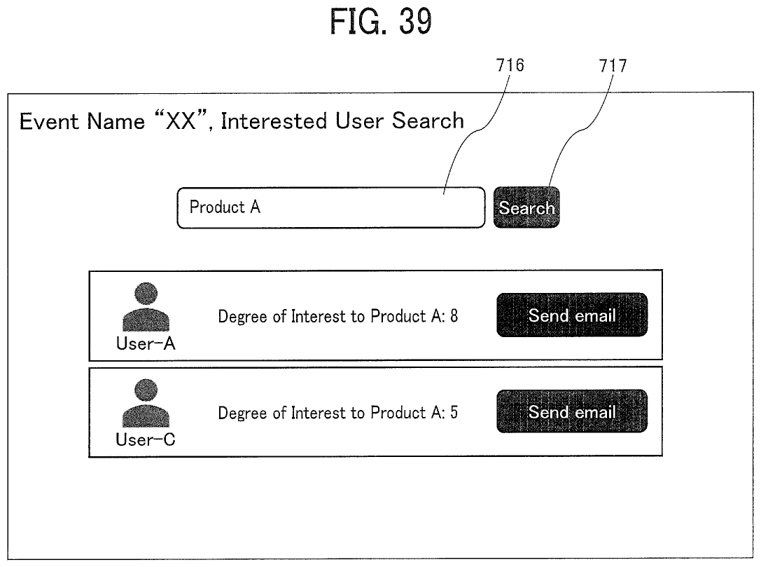

FIG. 39 is an illustration of an example of a keyword search screen.

The organizer searches the degree of interest of the participants on the portal, for example. In this example, the organizer enters a search keyword in a keyword input field 716, for example, and presses a search button 717. In response this operation by the participant, the display control unit 25a of the personal terminal 2a displays one or more participants who are interested in the search keyword.

Accordingly, in a case in which the event is a sales seminar, for example, the organizer can send an e-mail about to a target product to the participant(s) based on the search result.

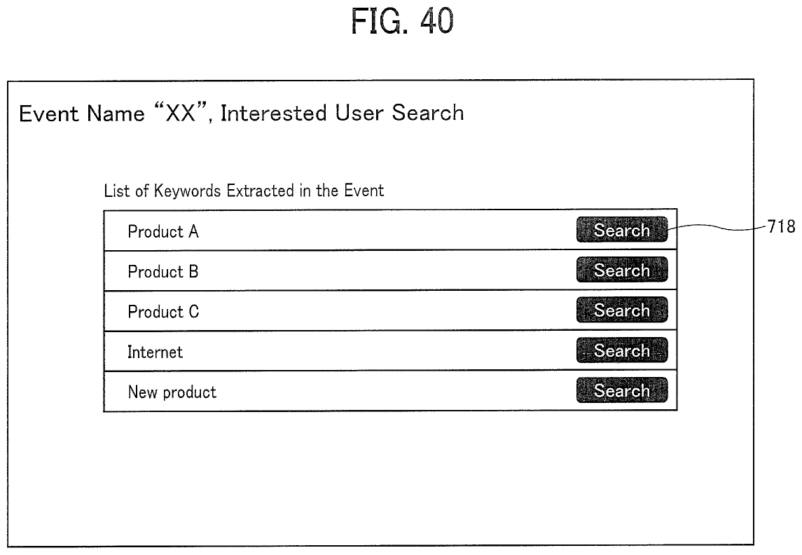

FIG. 40 is an illustration of an example of a keyword list display screen.

Keywords associated with an event is displayed in a list in response to the organizer's operation. In this case, the organizer presses a search button 718 provided for each keyword. In response to this operation, the display control unit 25a of the personal terminal 2a displays one or more participants who are interested in the corresponding keyword.

In the related art, for a document including multiple image files, a part in which a participant is interested in an image such as importance of the document is identified on file-by-file basis. In other words, the part in which the participant is interested in is not identified as a part of one image.

According to one or more embodiments of the present disclosure, an information processing apparatus that identifies a part of an image where a participant has performed an operation.

According to one or more embodiments, a method is provided that is performed by an information processing apparatus connected to a first communication terminal and a second communication terminal through a network. The method includes receiving operation information indicating an operation performed on a capture image at the second communication terminal, the capture image being an image captured by the second communication terminal from a shared screen shared by the first communication terminal, the second communication terminal, and another communication terminal. The method further includes identifying a part where the operation is performed on the capture image, based on the received operation information. The method further includes transmitting information on the part where the operation is performed to the first communication terminal.

The above-described embodiment is one example and, for example, the following aspects 1 to 10 of the present disclosure can provide the following advantages.

Aspect 1:

According to an aspect 1, the content management server 6 (an example of an information processing apparatus) is connected to the personal terminal 2a (an example of a first communication terminal) and a personal terminal 2b (an example of a second communication terminal) through a network. The content management server 6 manages a shared screen shared by the personal terminal 2b, the personal terminals 2a, and the personal terminal 2c (an example of another communication terminal) and a capture image captured from the shared screen by the personal terminal 2b. The content management server 6 includes the data exchange unit 61 (an example of reception means) configured to receive operation information indicating an operation performed on the capture image at the personal terminal 2b. The content management server 6 further includes the identification unit 63 (an example of identification means) configured to identify a part where the operation is performed on the capture image, based on the operation information received by the data exchange unit 61. The data exchange unit 61 (an example of transmission means) is further configured to transmit information on the part where the operation is performed to the personal terminal 2a.

According to the aspect 1, a part where the participant performs an operation on an image is identified based on the operation information indicating the operation performed on the capture image at the personal terminal 2b.

Aspect 2:

According to an aspect 2, in the aspect 1, the operation information includes a sheet ID (an example of page information) based on which the capture image is registered as a favorite page. The identification unit 63 (an example of identification means) identifies, based on the sheet ID, an entire page corresponding to the sheet ID as the part where the operation is performed.

Aspect 3:

According to an aspect 3, in the aspect 1, the operation information includes coordinate information of a fixed object added to the capture image. The identification unit 63 (an example of identification means) identifies a position at which the fixed object is added as the part where the operation is performed, based on the coordinate information.

Aspect 4:

According to an aspect 4, in the aspect 1, the operation information includes coordinate information of an object drawn on the capture image. The identification unit 63 (an example of identification means) identifies a position at which the object is drawn as the part where the operation is performed, based on the coordinate information.

Aspect 5:

According to an aspect 5, in the aspect 4, the identification unit 63 (an example of identification means) identifies a position at which the object is drawn as a figure as the part where the operation is performed.

Aspect 6:

According to an aspect 6, in the aspect 4 or the aspect 5, the operation information includes color information of the object. The identification unit 63 (an example of identification means) identifies a position at which the object is drawn in a color other than black as the part where the operation is performed, based on the color information.

Aspect 7:

According to an aspect 7, in the aspect 1, the operation information includes a sheet ID (an example of page information) identifying a capture image for which viewing is performed with respect to the capture image. The identification unit 63 (an example of identification means) identifies, based on the sheet ID, an entire page corresponding to the sheet ID as the part where the operation is performed.

Aspect 8:

According to an aspect 8, in the aspect 1, the operation information includes line-of-sight information indicating a line-of-sight of a user operating the personal terminal 2b (an example of a second communication terminal) with respect to the capture image. The identification unit 63 (an example of identification means) identifies a position viewed by the user with respect to the capture image as the part where the operation is performed, based on the line-of-sight information.

According to the aspect 2 to the aspect 8, the organizer can recognize the information on the part where the participant performs the operation on the image in more detail.

Aspect 9:

According to an aspect 9, in the aspect 1, the content management server 6 further includes the collation unit 64 (an example of collation means) configured to collate the information on the part where the operation is performed with image information in which the rectangle 915 (an example of a collation area) is set by the personal terminal 2a (an example of a first communication terminal) for collation with respect to the information on the part where the operation is performed The data exchange unit 61 (an example of transmission means) is further configured to transmit a collation result by the collation unit 64 to the personal terminal 2a.

Aspect 10:

According to an aspect 10, in the aspect 9, the image information in which the rectangle 915 (an example of the collation area) is set includes keyword information assigned by the personal terminal 2a (an example of the first communication terminal) to the information on the part where the operation is performed.

According to the aspect 9 and the aspect 10, the organizer can obtain desired information in a short time with respect to the information on the part where the participant performs the operation on the image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An information processing apparatus connected to a first communication terminal and a second communication terminal through a network, the information processing apparatus comprising circuitry configured to:
receive operation information indicating an operation performed on a capture image at the second communication terminal, the capture image being an image captured by the second communication terminal from a shared screen shared by the first communication terminal, the second communication terminal, and another communication terminal;
identify a part where the operation is performed on the capture image, based on the received operation information; and
transmit information on the part where the operation is performed to the first communication terminal.

2. The information processing apparatus of claim 1, wherein
the operation information includes page information based on which the capture image is registered as a favorite page, and
the circuitry identifies an entire page corresponding to the page information as the part where the operation is performed.

3. The information processing apparatus of claim 1, wherein
the operation information includes coordinate information of a fixed object added to the capture image, and
the circuitry identifies a position at which the fixed object is added as the part where the operation is performed, based on the coordinate information.

4. The information processing of claim 1, wherein
the operation information includes coordinate information of an object drawn on the capture image, and
the circuitry identifies a position at which the object is drawn as the part where the operation is performed, based on the coordinate information.

5. The information processing apparatus of claim 4, wherein
the circuitry identifies the position at which the object is drawn as a figure as the part where the operation is performed.

6. The information processing apparatus of claim 5, wherein
the operation information includes color information of the object, and
the circuitry identifies a position at which the object is drawn in a color other than black as the part where the operation is performed, based on the color information.

7. The information processing apparatus of claim 1, wherein
the operation information includes page information of the capture image for which viewing is performed, and
the circuitry identifies an entire page corresponding to the page information as the part where the operation is performed.

8. The information processing apparatus of claim 1, wherein
the operation information includes line-of-sight information indicating a line-of-sight of a user operating the second communication terminal with respect to the capture image, and
the circuitry identifies a position viewed by the user with respect to the capture image as the part where the operation is performed, based on the line-of-sight information.

9. The information processing apparatus of claim 1, wherein
the circuitry
collates the information on the part where the operation is performed with image information in which a collation area with respect to the information on the part where the operation is performed is set, the collation area being set by the first communication terminal, and
transmits a collation result to the first communication terminal.

10. The information processing apparatus of claim 9,
the image information in which the collation area is set includes keyword information assigned by the first communication terminal to the information on the part where the operation is performed.

11. A non-transitory computer-executable medium storing a program to cause an information processing apparatus connected to a first communication terminal and a second communication terminal through a network to perform a method, the method comprising:
receiving operation information indicating an operation performed on a capture image at the second communication terminal, the capture image being an image captured by the second communication terminal from a shared screen shared by the first communication terminal, the second communication terminal, and another communication terminal;
identifying a part where the operation is performed on the capture image, based on the received operation information; and
transmitting information on the part where the operation is performed to the first communication terminal.

12. An information processing system connected to a first communication terminal and a second communication terminal through a network, the information processing system comprising circuitry configured to:
receive operation performed on a capture image displayed on the second communication terminal, the capture image being an image captured by the second communication terminal from a shared screen shared by the first communication terminal, the second communication terminal, and another communication terminal;
identify a part where the operation is performed on the capture image, based on operation information indicating the received operation; and
cause the first communication terminal to display information on the part where the operation is performed.

13. An information processing system comprising:
the information processing apparatus of claim 1; and
the first communication terminal,
wherein the first communication terminal includes circuitry configured to display a screen based on the information on the part where the operation is performed, the information being received from the information processing apparatus.
